(19) United States
(12) Patent Application Publication
(10) Pub. No.: US 2024/0114516 A1
(43) Pub. Date: Apr. 4, 2024

(54) ENHANCEMENT FOR HARQ ACK FOR MESSAGE 4 OR MESSAGE B

(71) Applicant: QUALCOMM Incorporated, San Diego, CA (US)

(72) Inventors: Liangping MA, San Diego, CA (US); Xiao Feng WANG, San Diego, CA (US); Umesh PHUYAL, San Diego, CA (US); Bharat SHRESTHA, San Diego, CA (US); Alberto RICO ALVARINO, San Diego, CA (US); Jae Ho RYU, San Diego, CA (US); Lianghai JI, San Diego, CA (US); Changhwan PARK, San Diego, CA (US); Ayan SENGUPTA, San Diego, CA (US); Wanshi CHEN, San Diego, CA (US)

(21) Appl. No.: 18/471,997

(22) Filed: Sep. 21, 2023

Related U.S. Application Data
(60) Provisional application No. 63/377,721, filed on Sep. 29, 2022.

(51) Int. Cl. H04W 72/21; H04L 1/1812; H04W 72/1273; H04W 74/08; H04W 76/20

(52) U.S. Cl. CPC H04W 72/21; H04L 1/1812; H04W 72/1273; H04W 74/0833; H04W 76/20

(57) ABSTRACT

Aspects are provided for enhancing HARQ ACK for Message 4 or Message B. An apparatus may obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message. The PUCCH transmission includes a Hybrid Automatic Repeat Request (HARQ) feedback message in response to receiving a message on a Physical Downlink Shared Channel (PDSCH) in a random access procedure. The PUCCH transmission may then be transmitted on a PUCCH according to the number of repetitions. This allows coverage techniques to be applied to certain transmissions in order to improve coverage and reliability. In an aspect, the coverage enhancement techniques may include repetition of a transmission for coverage extension.

### CROSS REFERENCE TO RELATED APPLICATION(S)

This application claims the benefit of U.S. Provisional Application Ser. No. 63/377,721, entitled “ENHANCEMENT FOR HARQ ACK FOR MSG4 or MSGB” and filed on Sep. 29, 2022, which is expressly incorporated by reference herein in its entirety.

### TECHNICAL FIELD

This disclosure relates generally to wireless communication, and more specifically, to techniques for repeating a configuration for a transmission with a resource set.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communication. The apparatus includes a memory and a processor coupled to the memory. The processor is configured to obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message. The PUCCH transmission includes a Hybrid Automatic Repeat Request (HARQ) feedback message in response to receiving a message on a Physical Downlink Shared Channel (PDSCH) in a random access procedure. The processor is further configured to transmit the PUCCH transmission on a PUCCH according to the number of repetitions.

A further aspect of the subject matter described in this disclosure can be implemented in an apparatus for wireless communication. The apparatus includes a memory and at least one processor coupled to the memory. The processor is also configured to transmit a message on a Physical Downlink Shared Channel (PDSCH) channel in a random access procedure. The processor is further configured to transmit a configuration indicating a number of repetitions for a scheduled PUCCH transmission in a plurality of slots prior to activation of a dedicated PUCCH resource configuration with a plurality of repetitions based on a radio resource control (RRC) message. The scheduled PUCCH transmission includes a Hybrid Automatic Repeat Request (HARQ) feedback message indicating a reception status of the message. The processor is further configured to obtain the repetition for the scheduled PUCCH transmission on a PUCCH.

Another further aspect of the subject matter described in this disclosure can be implemented in a method of wireless communication at a UE. The method includes obtaining a configuration indicating a number of repetitions for a physical uplink control channel (PUCCH) transmission in a plurality of slots prior to activation of a dedicated PUCCH resource configuration with a plurality of repetitions based on a radio resource control (RRC) message. The PUCCH transmission includes a Hybrid Automatic Repeat Request (HARQ) feedback message in response to receiving a message on a Physical Downlink Shared Channel (PDSCH) in a random access procedure. The method also includes transmitting the PUCCH transmission on the PUCCH according to the number of repetitions.

Another further aspect of the subject matter described in this disclosure can be implemented in a method of wireless communication at a base station. The method includes transmitting information indicating a scheduled physical uplink control channel (PUCCH) transmission on a PUCCH resource. The method also includes transmitting a message on a Physical Downlink Shared Channel (PDSCH) channel in a random access procedure. The method further includes transmitting a configuration indicating a number of repetitions for the scheduled PUCCH transmission in a plurality of slots prior to activation of a dedicated PUCCH resource configuration with a plurality of repetitions based on a radio resource control (RRC) message. The scheduled PUCCH transmission includes a Hybrid Automatic Repeat Request (HARQ) feedback message indicating a reception status of the message. The message also includes obtaining the repetition for the scheduled PUCCH transmission on the PUCCH.

Another further aspect of the subject can be implemented in an apparatus for wireless communication. The apparatus includes means for obtaining a configuration indicating a number of repetitions for a physical uplink control channel (PUCCH) transmission in a plurality of slots prior to activation of a dedicated PUCCH resource configuration with a plurality of repetitions based on a radio resource control (RRC) message. The PUCCH transmission includes a Hybrid Automatic Repeat Request (HARQ) feedback message in response to receiving a message on a Physical Downlink Shared Channel (PDSCH) in a random access procedure. The apparatus further includes means for transmitting the PUCCH transmission on the PUCCH according to the number of repetitions.

Another further aspect of the subject can be implemented in an apparatus for wireless communication. The apparatus includes means for transmitting information indicating a scheduled physical uplink control channel (PUCCH) transmission on a PUCCH resource. The means for transmitting is further configured to transmit a message on a Physical Downlink Shared Channel (PDSCH) in a random access procedure, and to transmit a configuration indicating a number of repetitions for the scheduled PUCCH transmission in a plurality of slots prior to activation of a dedicated PUCCH resource configuration with a plurality of repetitions based on a radio resource control (RRC) message. The scheduled PUCCH transmission includes a Hybrid Automatic Repeat Request (HARQ) feedback message indicating a reception status of the message. The apparatus further includes means for obtaining a repetition for the scheduled PUCCH transmission on the PUCCH.

Another further aspect of the subject matter described in this disclosure can be implemented in a non-transitory computer-readable medium storing computer-executable code including stored instructions of communications, executable by a processor to: obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message, wherein the PUCCH transmission includes a Hybrid Automatic Repeat Request (HARQ) feedback message in response to receiving a message on a Physical Downlink Shared Channel (PDSCH) in a random access procedure; and transmit the PUCCH transmission on the PUCCH according to the number of repetitions.

Another further aspect of the subject matter described in this disclosure can be implemented in a non-transitory computer-readable medium storing computer-executable code, the code when executed by a processor cause the processor to: transmit a message on a Physical Downlink Shared Channel (PDSCH) channel in a random access procedure; transmit a configuration indicating a number of repetitions for a scheduled PUCCH transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARQ) feedback message indicating a reception status of the message; and obtain the repetition for the scheduled PUCCH transmission on a PUCCH.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 is a diagram illustrating an example of a wireless communications system and an access network.

FIG. 2 is a diagram illustrating an example disaggregated base station architecture.

FIG. 3A is a diagram illustrating an example of a first frame, in accordance with various aspects of the present disclosure.

FIG. 3B is a diagram illustrating an example of downlink channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink channels within a subframe, in accordance with various aspects of the present disclosure.

FIG. 4 is a diagram illustrating an example of a base station and user equipment (UE) in an access network.

FIGS. 5 through 9 illustrate examples of call flow diagrams between a base station and a UE.

FIGS. 10 through 14 illustrate example flowcharts illustrating methods of wireless communication at a UE.

FIGS. 15 through 19 illustrates example flowcharts illustrating methods of wireless communication at a base station.

FIG. 20 is a diagram illustrating an example of a hardware implementation for an example apparatus.

FIG. 21 is a diagram illustrating another example of a hardware implementation for another example apparatus.

Like reference numbers and designations in the various drawings indicate like elements.

### DETAILED DESCRIPTION

The following description is directed to some particular aspects for the purposes of describing innovative aspects of this disclosure. However, a person having ordinary skill in the art will readily recognize that the teachings herein can be applied in a multitude of different ways. The described aspects can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described aspects can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described aspects also can be implemented using other wireless communication protocols or RF signals suitable for use in one or more of a wireless personal area network (WPAN), a wireless local area network (WLAN), a wireless wide area network (WWAN), or an internet of things (IOT) network.

In non-terrestrial networks (NTN), there is a large distance between user equipment (UE) and receiver (e.g., satellite or base station) in satellite-based communication due to Hybrid Automatic Repeat Request (HARQ) Acknowledgement (ACK) being sent in uplink on a Physical Uplink Control Channel (PUCCH). Accordingly, HARQ ACK may fail with a high probability due to the large distance without coverage enhancement such as repetition. Currently, for PUCCH before dedicated PUCCH resource configuration, there is no repetition associated with the PUCCH resource set or mechanisms to enhance the robustness of the message.

In order to improve coverage and reliability, coverage enhancement techniques may be applied to certain transmissions, such as a PUCCH transmission. Specifically, the coverage enhancement techniques may include repetition of a transmission for coverage extension because HARQ ACK cannot meet target requirements without repetition. For instance, after an initial access procedure, PUCCH may use repetitions of PUCCH transmission to allow the receiver to connect and combine the PUCCH transmission data copies in the decoding of the HARQ ACK. However, the available HARQ-ACK PUCCH configuration may not be supported before random access is completed. In addition, there is currently no PUCCH repetition configuration associated with PUCCH transmissions such as HARQ ACK in response to Message 4 or Message B during random access procedures.

PUCCH repetitions may be supported when the PUCCH transmission is scheduled using dedicated PUCCH resources. PUCCH repetitions may not be supported when the PUCCH transmission is scheduled via a PUCCH resource set that is provided via system information (e.g., system information block 1 (SIB1)), as is the case for the HARQ-ACK transmission on PUCCH in response to Message 4 or Message B (i.e., PUCCH transmission during random access procedures). However, Message 4 HARQ ACK is sent in a PUCCH transmission before the dedicated PUCCH resource configuration and there is no repetition associated with the PUCCH resources set. Thus, it would be helpful if the performance of PUCCH carrying the HARQ ACK bit for Message 4 or Message B could be enhanced in coverage limited scenarios.

As described in further detail in the present disclosure, PUCCH repetition may be performed to increase coverage extension during random access procedures. In particular, a UE may perform repetition on a PUCCH transmission that contains a HARQ-ACK feedback for a contention resolution PDSCH transmission in a random access procedure. The PUCCH transmission may then be transmitted on resources prior to activation of dedicated PUCCH resource configuration.

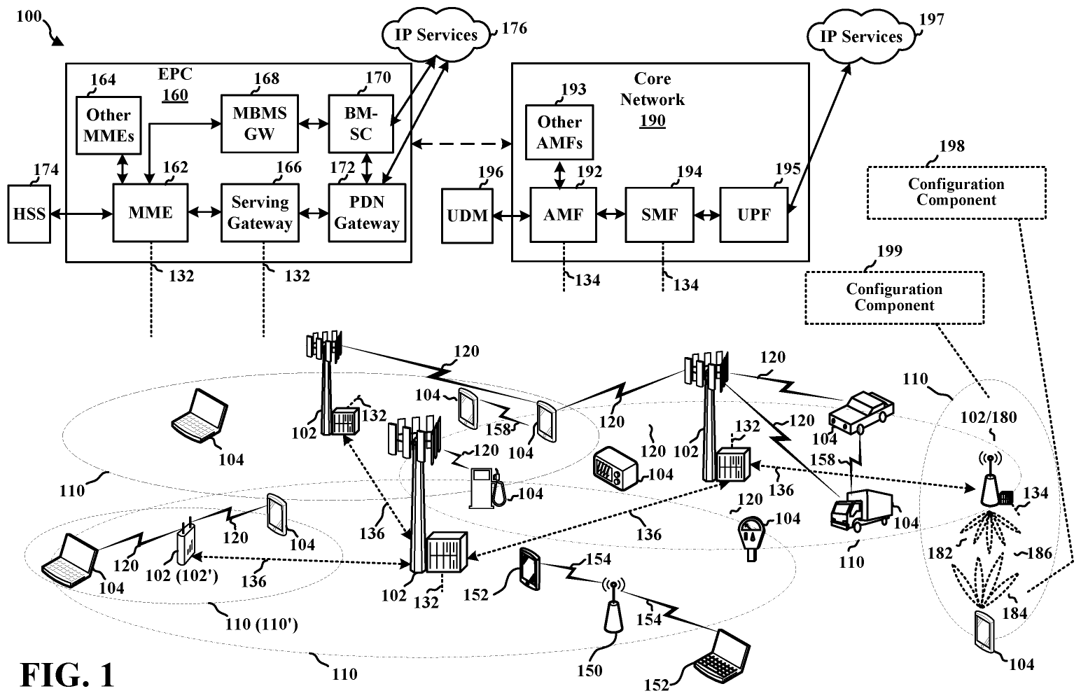

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells, such as high power cellular base stations, and/or small cells, such as low power cellular base stations (including femtocells, picocells, and microcells).

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as the Next Generation Radio Access Network (RAN) (NG-RAN), may interface with a core network 190 through second backhaul links 134. In addition to other functions, the base stations 102 may perform one or more of: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In an aspect, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for integrated access and backhaul (IAB). Accordingly, such base stations may wirelessly communicate with other base stations, which also may be configured for TAB.

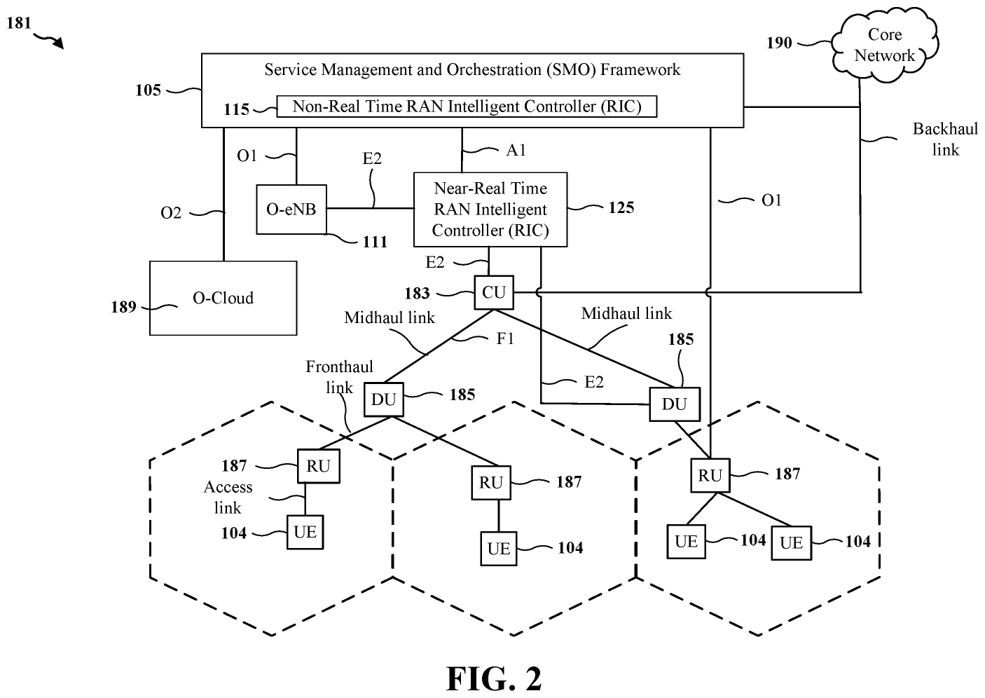

At least some of the base stations 102 configured for IAB may have a split architecture including multiple units, some or all of which may be collocated or distributed and which may communicate with one another. For example, FIG. 2, infra, illustrates an example disaggregated base station 200 architecture that includes at least one of a central unit (CU) 210, a distributed unit (DU) 230, a radio unit (RU) 240, a remote radio head (RRH), a remote unit, and/or another similar unit configured to implement one or more layers of a radio protocol stack.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.).

A UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cells and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances, in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band. In some aspects, “mmW” or “near-mmW” may additionally or alternatively refer to a 60 GHz frequency range, which may include multiple channels outside of 60 GHz. For example, a 60 GHz frequency band may refer to a set of channels spanning from 57.24 GHz to 70.2 GHz.

In view of the foregoing, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102 may be implemented as a macro base station providing a large cell or may be implemented as a small cell 102′ having a small cell coverage area. Some base stations 102 may operate in a traditional sub-6 GHz (or sub-7 GHz) spectrum, in mmW frequencies, and/or near-mmW frequencies in communication with the UE 104. When such a base station operates in mmW or near-mmW frequencies, the base station may be referred to as a mmW base station 180. The mmW base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the base stations 102/180 may be connected to the EPC 160 and may provide respective access points to the EPC 160 for one or more of the UEs 104. The EPC 160 may include a Mobility Management Entity (MME) 162, other MMES 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

In an aspect, the UE 104 may include a configuration component 198 that is configured to obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message. The PUCCH transmission may include a Hybrid Automatic Repeat Request (HARQ) feedback message in response to receiving a message on a Physical Downlink Shared Channel (PDSCH) in a random access procedure. The configuration component 198 may also be configured to transmit the PUCCH transmission on the PUCCH according to the number of repetitions.

In an aspect, the base station 102/180 (e.g., network entity or a network node, such as a gNB) may include a configuration component 199 that is configured to transmit a message on a Physical Downlink Shared Channel (PDSCH) channel in a random access procedure. The configuration component 199 may further be configured to transmit a configuration indicating a first number of repetitions for a scheduled PUCCH transmission in a plurality of slots prior to activation of a dedicated PUCCH resource configuration with a plurality of repetitions based on a radio resource control (RRC) message. The scheduled PUCCH transmission may include a Hybrid Automatic Repeat Request (HARQ) feedback message indicating a reception status of the message. The configuration component 199 may be configured to obtain a repetition of the PUCCH transmission on a PUCCH.

FIG. 2 shows a diagram illustrating an example disaggregated base station 181 architecture. The disaggregated base station 181 architecture may include one or more CUs 183 that can communicate directly with core network 190 via a backhaul link, or indirectly with the core network 190 through one or more disaggregated base station units (such as a Near-Real Time RIC 125 via an E2 link, or a Non-Real Time MC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 183. The CU 183 may be configured to handle user plane functionality (i.e., Central Unit—User Plane (CU-UP)), control plane functionality (i.e., Central Unit—Control Plane (CU-CP)), or a combination thereof. In some implementations, the CU 183 can be logically split into one or more CU-UP units and one or more CU-CP units. The CU-UP unit can communicate bidirectionally with the CU-CP unit via an interface, such as the E1 interface when implemented in an O-RAN configuration. The CU 183 can be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) can be implemented with an interface configured to communicate signals with other layers (and modules) hosted by the DU 185, or with the control functions hosted by the CU 183.

Lower-layer functionality can be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 can be implemented to handle over the air (OTA) communication with one or more UEs 104. In some implementations, real-time and non-real-time aspects of control and user plane communication with the RU(s) 187 can be controlled by the corresponding DU 185. In some scenarios, this configuration can enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements can include, but are not limited to, CUs 183, DUs 185, RUs 187 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

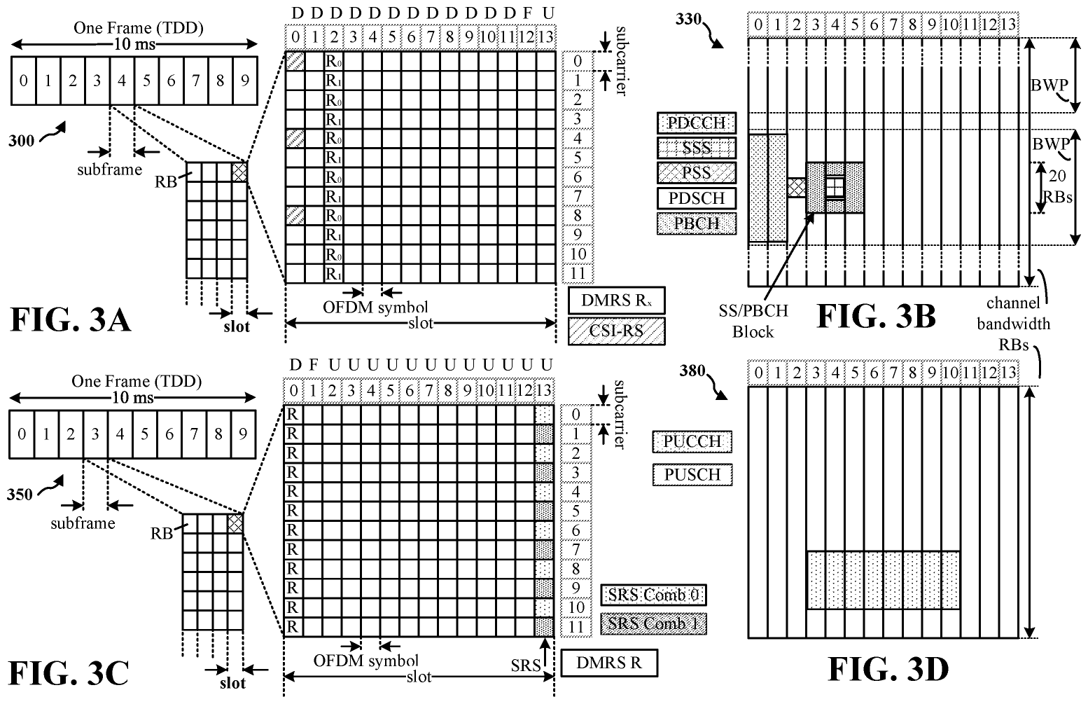

FIG. 3A is a diagram illustrating an example of a first subframe 300 within a 5G NR frame structure. FIG. 3B is a diagram illustrating an example of downlink channels within a 5GNR subframe 330. FIG. 3C is a diagram illustrating an example of a second subframe 350 within a 5GNR frame structure. FIG. 3D is a diagram illustrating an example of uplink channels within a 5GNR subframe 380. The 5GNR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 3A and 3C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 3B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 3B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. A UE (such as a UE 104 of FIG. 1) may use the PSS to determine subframe/symbol timing and a physical layer identity. A secondary synchronization signal (SSS) may be within symbol 4 of particular subframes of a frame. A UE (such as a UE 104 of FIG. 1) may use the SSS to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIGs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 3D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARD) acknowledgement (ACK)/non-acknowledgement (NACK) feedback. The PUSCH carries data, and may additionally be used to carry a buffer status report (BSR), a power headroom report (PHR), and/or UCI.

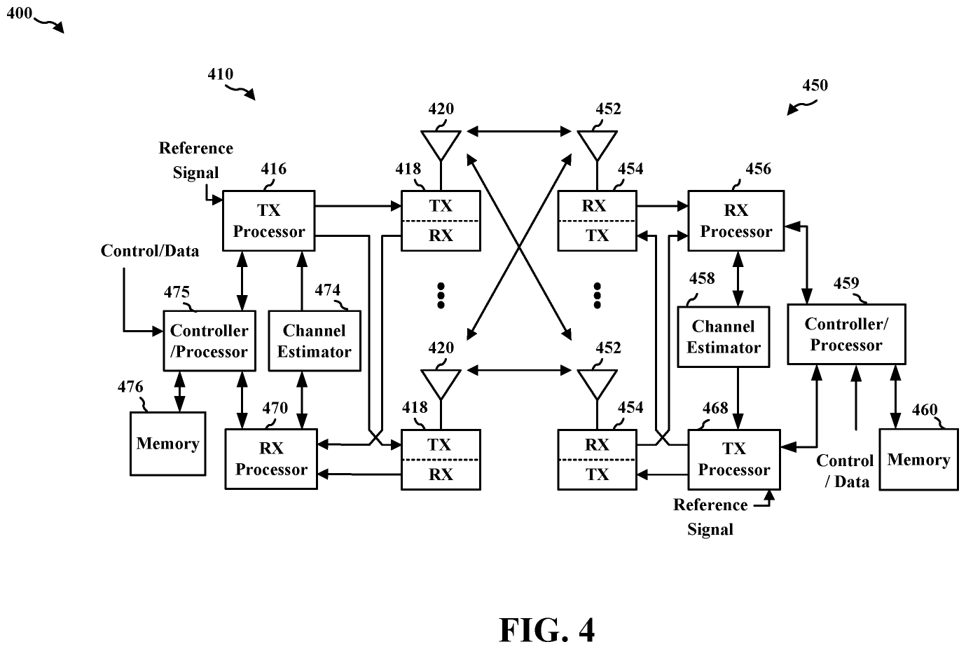

FIG. 4 is a block diagram of a base station 410 in communication with a UE 450 in an access network 400. In the downlink, IP packets from the EPC 160 may be provided to a controller/processor 475. The controller/processor 475 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 475 provides RRC layer functionality associated with broadcasting of system information (e.g., MIB, Ms), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement Layer 1 (L1) functionality associated with various signal processing functions. L 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially pre-coded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate a radio frequency (RF) carrier with a respective spatial stream for transmission.

At the UE 450, each receiver 454RX receives a signal through at least one respective antenna 452. Each receiver 454RX recovers information modulated onto an RF carrier and provides the information to the receive (RX) processor 456. The TX processor 468 and the RX processor 456 implement L1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements L3 and L2 functionality.

The controller/processor 459 can be associated with a memory 460 that stores program codes and data. The memory 460 may be referred to as a computer-readable medium. In the uplink, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the downlink transmission by the base station 410, the controller/processor 459 provides RRC layer functionality associated with system information (e.g., MIB, SIBS) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The uplink transmission is processed at the base station 410 in a manner similar to that described in connection with the receiver function at the UE 450. Each receiver 418RX receives a signal through at least one respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the uplink, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

At least one of the TX processor 468, the RX processor 456, and the controller/processor 459 may be configured to perform aspects in connection with the configuration component 198 of FIG. 1.

At least one of the TX processor 416, the RX processor 470, and the controller/processor 475 may be configured to perform aspects in connection with the configuration component 199 of FIG. 1.

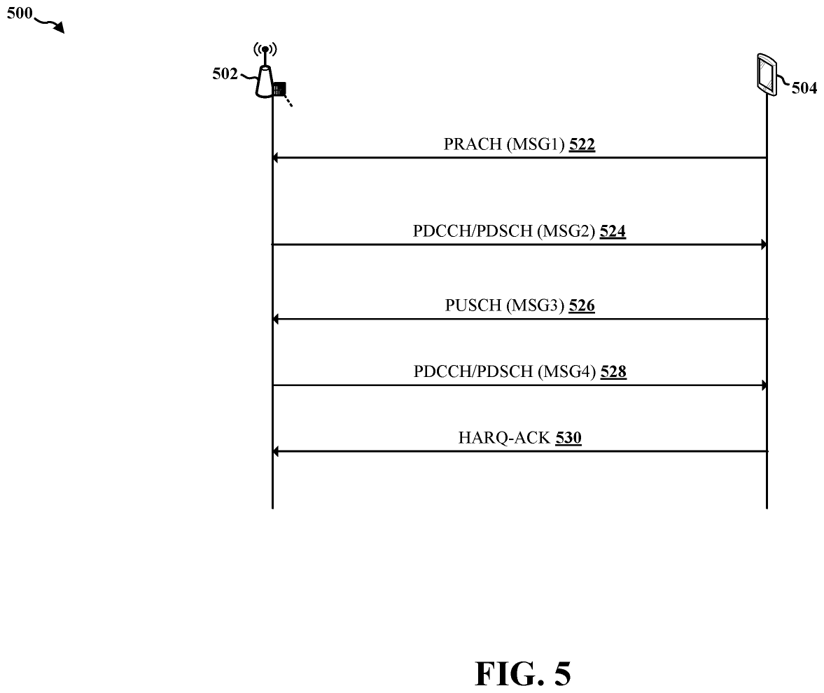

FIG. 5 illustrates an example of a wireless communication system 500 that supports a four-step random access channel (RACH) procedure in accordance with various aspects of the present disclosure. In some examples, wireless communication system 500 may implement aspects of access network 100. For example, wireless communication system 500 includes UE 504 and base station 502, which may be examples of the corresponding devices described with reference to FIG. 1. Wireless communication system 500 may support random access procedures for UEs 504 that initiate access to a base station 502.

As seen in FIG. 5, a typical RACH procedure may involve four transmissions. First, a UE 504 may transmit Message 1 on the physical random access channel (PRACH) at 522. The Message 1 transmission is a first transmission that may include a PRACH preamble, including timing information for uplink transmissions that allow the base station 502 to set timing advance parameters, for example. In response to receiving Message 1, the base station 502 may transmit a Message 2 transmission on the PDCCH or PDSCH at 524. The Message 2 transmission may also be referred to as a random access response (RAR) message, and the contents may include timing advance parameters or information, an uplink grant for the UE's 504 Message 3 transmission on the uplink, a temporary cell radio network temporary identifier (TC-RNTI), and the like. In some instances, the TC-RNTI may be sent to the UE 504 to indicate the scrambling sequence used for Message 4 transmission.

After receiving Message 2 or the RAR, the UE 504 may then transmit Message 3 on PUSCH at 526 using resources scheduled by the uplink grant of Message 2. In some instances, the contents of Message 3 may include an RRC connection request, a scheduling request, a buffer status of the UE 504, or the like. The base station 502 may then transmit a contention resolution message referred to as Message 4 on the PDCCH or PDSCH at 528. The UE 504 then sends a HARQ-ACK message at 530 to acknowledge that Message 4 was received at the UE 504 and the UE contention resolution identity in Message 4 matched the identity transmitted in Message 3. The RACH procedure depicted in FIG. 5 may be performed in various use cases, including for initial access to a network or cell, when a UE 504 transitions from an RRC Idle/Inactive state to an RRC Connected state (e.g., after receiving a paging message), or when a UE 504 is changing serving base stations 502 during a handover procedure. Further, in some instances, a UE 504 may use the RACH procedure described above to send small uplink data transmissions during RRC Idle/Inactive states in order to save on the overhead costs of leaving RRC Idle/Inactive states into RRC Connected state just to transmit a relatively small amount of data.

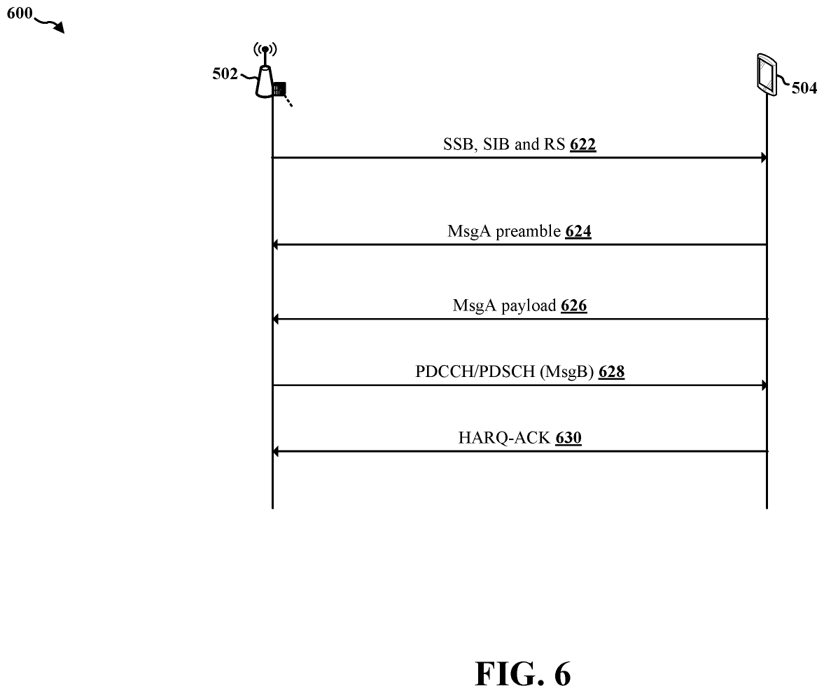

FIG. 6 illustrates an example of a wireless communication system 600 that supports a two-step RACH procedure in accordance with various aspects of the present disclosure. In some examples, wireless communication system 600 may implement aspects of access network 100. For example, wireless communication system 600 includes UE 504 and base station 502, which may be examples of the corresponding devices described with reference to FIG. 1. Wireless communication system 600 may support random access procedures for UEs 504 that initiate access to a base station 502.

As seen in FIG. 6, a base station 502 may transmit broadcast information to multiple UEs in a synchronization signal PBCH block (SS/PBCH block) at 622. The UE 504 may receive and decode the SS/PBCH block to obtain system information, perform synchronization procedures, and measure channel conditions based on reference signals received in the PBCH block. Based on the information obtained from the SS/PBCH block, the UE 504 may then initiate a two-step random access procedure by transmitting a first random access message Message A to the base station 502 at 624 and 626. The random access message Message A may be transmitted on both the PRACH and PUSCH, and may carry information similar to Message 1 and Message 3 of the four-step random access procedure described above with reference to FIG. 5. For example, Message A may include the random access preamble 624 on the PRACH as well as a random access payload 626 that includes an RRC connection request, a scheduling request, buffer status, and the like, on the PUSCH. In response, the base station 502 may transmit a random access response in Message B at 628. Message B may include timing advance information as well as a contention resolution message. In response to Message B, the contention resolution message, the UE 504 may send a HARQ-ACK message (e.g., ACK or NACK) at 630 to acknowledge whether Message B was successfully received.

For both the four-step RACH procedure described above with respect to FIG. 5 and the two-step RACH procedure described above with respect to FIG. 6, the HARQ-ACK message acknowledging the contention resolution message (Message 4 or Message B) may be transmitted prior to the UE 504 receiving a dedicated PUCCH resource configuration. In particular, the UE 504 may transmit the HARQ-ACK message on PUCCH resources that are assigned via indication in system information (e.g., SIB1). For example, the base station 502 may transmit an index in SIB1 (e.g., remaining minimum system information (RMSI)) that specifies which resources to use for the PUCCH transmission that includes the HARQ-ACK message based on a table known to the UE 504 and the base station 502. The index provided by the base station 502 may correspond to a particular row in a table, where the UE 504 can obtain the information for identifying a set of PUCCH resources that could be used for transmitting the HARQ-ACK message. As shown in Table 1, for example, if the base station 502 indicates to the UE 504 an index of 6 to use for PUCCH resource assignment, the UE 504 determines that a PUCCH transmission will comprise PUCCH format 1, will be transmitted on symbol 10 of the uplink slot, will comprise four symbols in length, and will have a PRB offset starting at four. As also determined from Table 1, the PUCCH transmission may have a cyclic shift based on a set of potential set of cyclic shift indexes comprising {0, 3, 6, 9}.

TABLE 1
PUCCH resource sets before dedicated PUCCH
resource configuration

| | | | | | Set of |
|---|---|---|---|---|---|
| In- | PUCCH | First | Number of | PRB | Initial CS |
| dex | format | symbol | symbols | offset | indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | IN^{SIZE}_{BWP}/4] | {0, 3, 6, 9} |

In reference to Table 1 above, a cell-specific PDCCH parameter provided in SIB (e.g., PUCCH-ConfigCommon IE) may indicate a resource set identified by a row in a table (see above Table 1 PUCCH resource set before a dedicated PUCCH resource configuration). However, there is no repetition associated with the resource set. In an aspect, the UE 504 may use the properties associated with the resource set (e.g., PRB offset, set of initial CS indexes) to compute an index rpuccH based on a combination of the PUCCH Resource Indicator (PRI) signaled in the DCI scheduling a PDSCH (that carries, e.g., Message 4) and the index of an allocated Control Channel Element (CCE) of the CORESET of the PDCCH (that carries the DCI). This allows the index rpuccH to determine a PUCCH resource for the HARQ Ack bit.

As described above, repetition may not be supported for PUCCH transmissions scheduled prior to configuration of dedicated PUCCH resources. Examples of PUCCH transmissions that may occur without or prior to configuration of dedicated PUCCH resources may include HARQ-ACK messages in response to Message 4 or Message B reception during random access procedures. Certain wireless communication deployments, however, may require further coverage enhancements. Accordingly, configuring PUCCH repetitions for HARQ-ACK messages prior to configuration of dedicated PUCCH resources may provide coverage enhancement benefits to a variety of applications. Specifically, PUCCH performance for carrying the HARQ ACK bit for the RRC configuration may be enhanced for both a normal contention scenario and an early contention scenario.

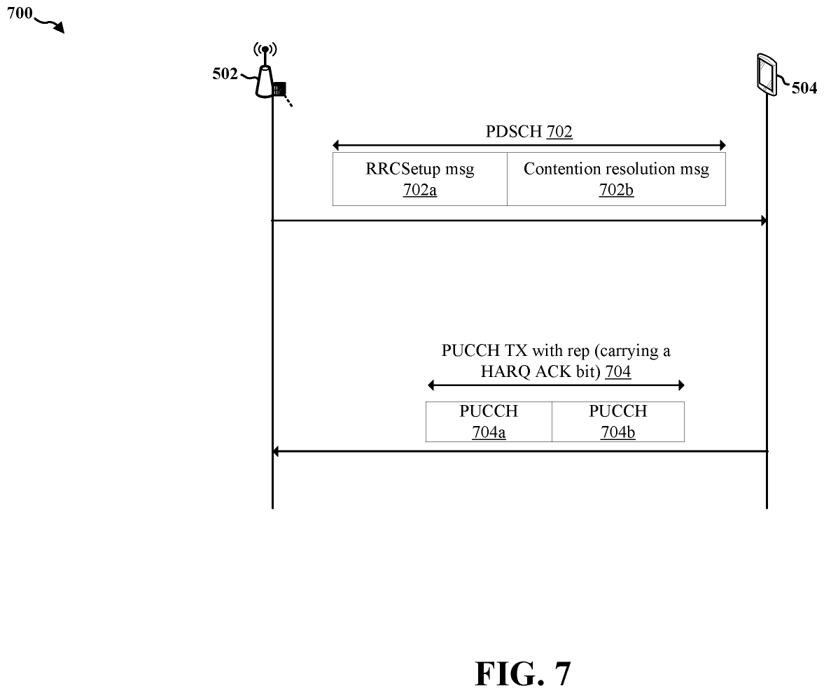

FIG. 7 is a call flow 700 diagram between a base station 502 and a UE 504. A call flow 700 illustrates an exemplary sequence of operations performed between the base station 502 and UE 504 to enhance HARQ ACK for Message 4 or Message B in a normal contention resolution case. For example, call flow 700 depicts operations for applying PUCCH repetition for HARQ-ACK messages prior to configuration of dedicated PUCCH resources. It is understood that one or more of the operations described in call flow 700 may be performed earlier or later in the process, omitted, replaced, supplemented, or combined with another operation. Also, additional operations described herein that are not included in call flow 700 may be included in call flow 700.

The UE 504 may correspond to UE 104, 450, and apparatus 2002. The base station 502 may correspond to base station 102/180, 410, and apparatus 2102.

Initially, the UE 504 may be configured to receive a PDSCH message carrying an RRC message (e.g., RRCSetup msg 702a or RRCReconfiguration msg) and a Message 4 (e.g., contention resolution msg 702b) at 702. In an aspect, the RRC message may activate a dedicated PUCCH resource configuration with a plurality of repetitions. In response to receiving the PDSCH 702, the UE 504 may be configured to transmit a PUCCH transmission (TX) with repetitions (carrying a HARQ ACK bit) according to a number of repetitions (configured prior to the dedicated PUCCH resource configuration, e.g., PUCCH 704a, PUCCH 704b) at 704 in response to receiving the Message 4 (e.g., contention resolution msg 702b) on the PDSCH in an random access procedure. In an aspect, the PDSCH message carrying an RRC message (e.g., RRC Setup msg 702a or RRCReconfiguration msg) and a contention resolution msg 702b is called Message 4.

In this way, the UE 504 may obtain a configuration indicating a number of repetitions for a PUCCH transmission in a plurality of slots prior to activation of a dedicated PUCCH resource configuration based on the Message 4 (e.g., contention resolution msg 702b). In this example, the number of repetitions is 2 as indicated by PUCCH 704a and PUCCH 704b. This allows a repetition to be associated with the PUCCH transmission.

It should be understood that the specific RRC messages and the number of repetitions used in call flow 700 diagram is non-limiting should be illustrative only.

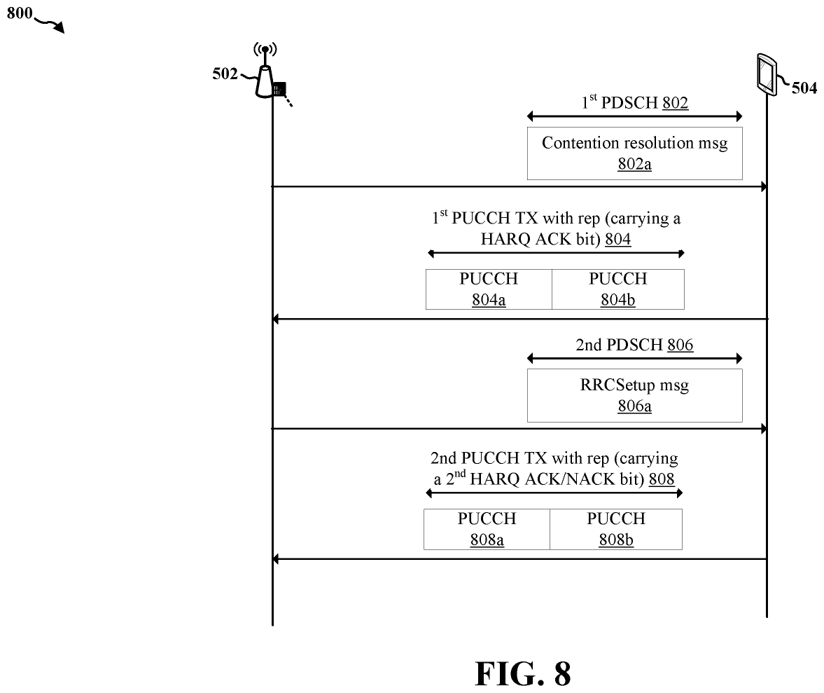

FIG. 8 is a call flow 800 diagram between a base station 502 and a UE 504. A call flow 800 illustrates an exemplary sequence of operations performed between the base station 502 and UE 504 to enhance HARQ ACK for Message 4 or Message B in an early contention resolution case. For example, call flow 800 depicts operations for applying PUCCH repetition for HARQ-ACK messages prior to configuration of dedicated PUCCH resources. It is understood that one or more of the operations described in call flow 800 may be performed earlier or later in the process, omitted, replaced, supplemented, or combined with another operation. Also, additional operations described herein that are not included in call flow 800 may be included in call flow 800.

In contrast to the call flow 700 diagram from FIG. 7, call flow 800 diagram shows a transmission of two PDSCHs, one carrying a HARQ ACK bit for the first PDSCH 802 and the other carrying a HARQ ACK/NACK bit for the second PDSCH 806. Here, Message 4 may be considered an early contention resolution message. Because it is an RRC transmission, the RRCSetup msg 806a and the contention resolution msg 802a will have their own corresponding HARQ ACK (804, 808).

When Message 4 or Message B are transmitted to the UE 504, there are two PDSCHs 802, 806.

Initially, the UE 504 is configured to receive a first PDSCH carrying a Message 4 (e.g., contention resolution msg 802a) at 802. In response to receiving the Message 4 (e.g., contention resolution msg 802a) on the first PDSCH 802 in an random access procedure, the UE may be configured to transmit a first PUCCH TX with repetitions (carrying a HARQ ACK bit) according to a number of repetitions (configured prior to the dedicated PUCCH resource configuration, e.g., two repetitions, PUCCH 804a, PUCCH 804b) at 804.

The UE 504 may also be configured to receive a second PDSCH carrying an RRC message (e.g., RRCSetup msg 806a, RRCReconfiguration message, or the like) at 806. There may be an RRC procedure delay (e.g., 10 ms) for the UE 504 to process the RRC message (e.g., RRCSetup msg 806a), in which PUCCH repetitions are configured in the dedicated PUCCH repetition configuration. At this point, before the RRC procedure delay, the UE 504 may not be able to determine the dedicated PUCCH repetition configuration. Accordingly, the UE may send a HARQ ACK bit (e.g., ACK, NACK, or discontinuous transmission (DTX)) for the second PDSCH 806 according to a number of repetitions (configured prior to the dedicated PUCCH resource configuration, e.g., two repetitions, PUCCH 808a, PUCCH 808b) at 808 without waiting for the RRC procedure delay. The DTX may mean that the UE 504 does not transmit anything because the UE may fail at decoding the PDSCH. From a network perspective this is considered a discontinuous transmission. For instance, when the UE 504 fails at decoding the PDSCH, then the UE 504 may determine there is a PDSCH and send a NACK. However, if the UE 504 fails at decoding the PDCCH scheduling the PDSCH, then the UE may not determine whether there is a PDSCH transmission so it would not be able to send the NACK. By doing so, the HARQ ACK enhancement for Message 4 or Message B may be applied to messages that expects an ACK and is before the application of an RRC configuration (e.g., via RRCSetup, RRCReconfiguration, or the like).

It should be understood that the specific RRC messages and the number of repetitions used in call flow 800 diagram are non-limiting should be construed as illustrative only.

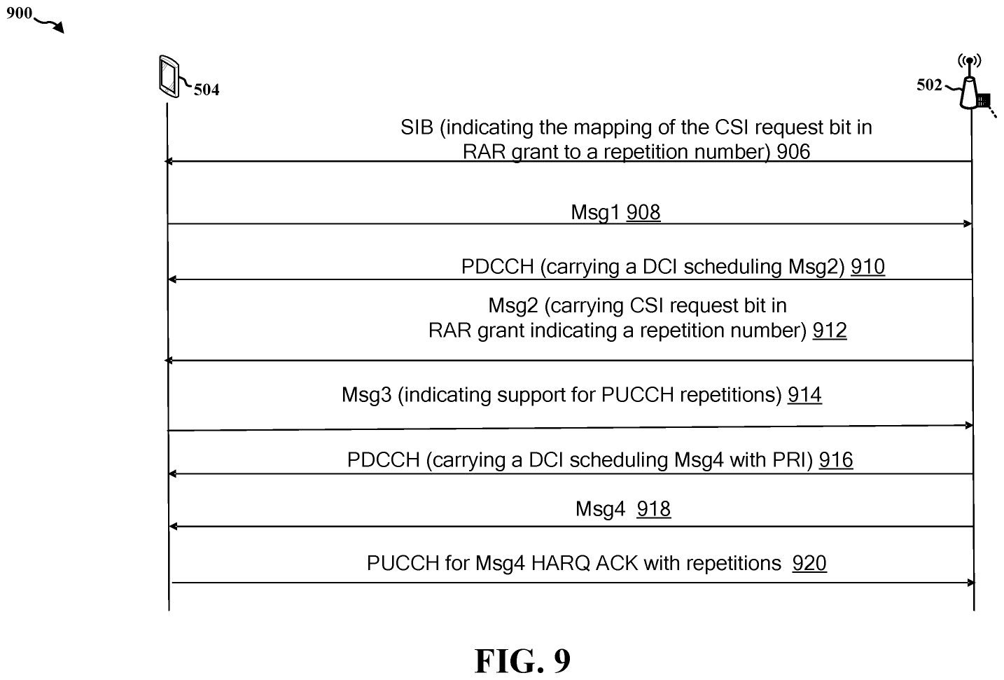

FIG. 9 is a call flow 900 diagram between a base station 502 and a UE 504. A call flow 900 illustrates an exemplary sequence of operations performed between the base station 502 and UE 504 to enhance HARQ ACK for Message 4 or Message B in an early contention resolution case. For example, call flow 900 depicts operations for applying PUCCH repetition for HARQ-ACK messages prior to configuration of dedicated PUCCH resources. It is understood that one or more of the operations described in call flow 900 may be performed earlier or later in the process, omitted, replaced, supplemented, or combined with another operation. Also, additional operations described herein that are not included in call flow 900 may be included in call flow 900.

The UE 504 may correspond to UE 104, 450, and apparatus 2002. The base station 502 may correspond to base station 102/180, 410, and apparatus 2102.

At 906, the base station 502 transmits a SIB indicating the mapping of the CSI request bit in RAR grant to a repetition number to the UE 504.

At 908, the UE 504 transmits a Message 1 to the UE base station 502.

At 910, the base station 502 transmits a PDCCH carrying a DCI scheduling Message 2 to the UE 504.

At 912, the base station 502 transmit a Message 2 carrying a CSI request bit in RAR grant indicating a repetition number to the UE 504.

At 914, the UE 504 transmits a Message 3 indicating support for PUCCH repetitions to the base station 502.

At 916, the base station 502 transmits a PDCCH carrying a DCI scheduling Message 4 with PRI to the UE 504.

At 918, the base station 502 transmits a Message 4 to the UE 504.

At 920, the UE 504 transmits a PUCCH for Message 4 HARQ ACK with repetitions to the base station 502.

It should be understood that the specific messages and the number of repetitions used in call flow 900 diagram is non-limiting should be illustrative only.

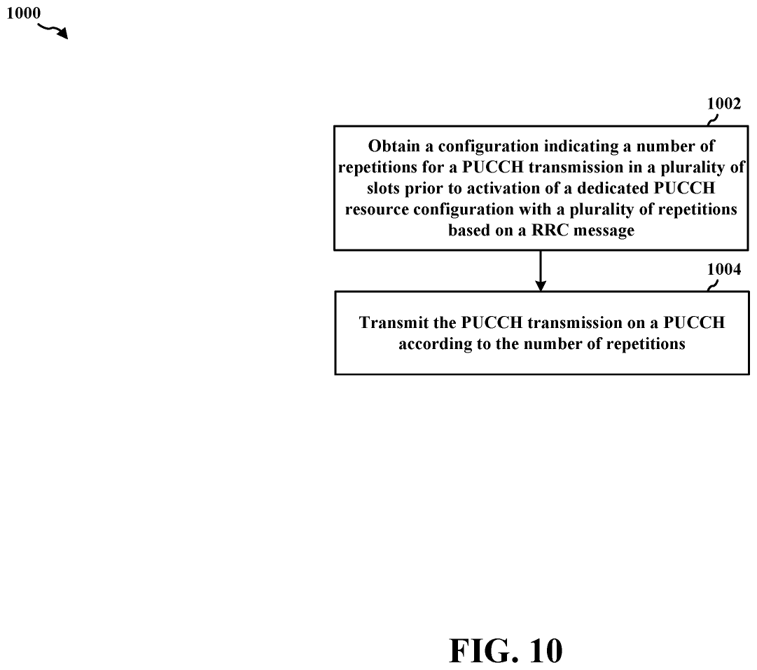

FIG. 10 is a flowchart of a method 1000 of wireless communication at a UE. The method 1000 may be performed by or at a UE (e.g., the UE 104, 450, 504), another wireless communications apparatus (e.g., the apparatus 2002), or one or more components thereof. According to various different aspects, one or more of the illustrated methods 1000 may be omitted, transposed, and/or contemporaneously performed. This method 1000 allows for enhancing the performance of PUCCH carrying the HARQ ACK bit for Message 4 or Message B.

The method 1000 may be performed by an apparatus, such as a configuration component 198, as described above. In some implementations, the method 1000 is performed by processing logic, including hardware, firmware, software, or a combination thereof. In some implementations, the method 1000 is performed by a processor executing code stored in a non-transitory computer-readable medium (e.g., a memory).

At operation 1002, the apparatus is configured to obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message. The PUCCH transmission includes a Hybrid Automatic Repeat Request (HARQ) feedback message in response to the apparatus receiving a message on a Physical Downlink Shared Channel (PDSCH) in a random access procedure. The message may be one of: a contention resolution message in a 4-step Random-Access Channel (RACH) procedure; a Message B (MsgB) in a 2-step RACH procedure; or any other message before the dedicated PUCCH resource configuration with the plurality of repetitions based on the RRC message. In an aspect, the apparatus may be a user equipment (UE). In an aspect, the configuration may be a in a SIB, a PUCCH ConfigCommon, in the RAR grant (e.g., the CSI request bit) in Msg2, in MsgB (e.g., repurpose one or more bits) in the case of two-step RACH, or a DCI.

In an aspect, the configuration is based on system information signaling such as SIB1.

In an aspect, the UE indicates its support for the configuration in the system information signaling, its support for the table describing PUCCH resource sets before receiving the dedicated PUCCH resource configuration, its support for the number of repetitions indicated in the RAR grant (e.g., the CSI request bit) in Msg2, or its support for the number of repetitions indicated in MsgB (e.g., repurpose one or more bits) based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0, e.g., using DMRS port 1; a PUSCH scrambling ID for a message 3 PUSCH; or a new DMRS sequence for Message 3 PUSCH.

In an aspect, the UE indicates its support for the configuration in the system information signaling, its support for the table describing PUCCH resource sets before receiving the dedicated PUCCH resource configuration, or its support for the number of repetitions indicated in the RAR grant (e.g., the CSI request bit) in Msg2, based on at least one of: a parameter associated with message 3 or a part of the content of message 3.

In an aspect, the UE indicates its selection for the configuration in the system information signaling, its selection for the table describing PUCCH resource sets before receiving the dedicated PUCCH resource configuration, its selection for the number of repetitions indicated in the RAR grant (e.g., the CSI request bit) in Msg2, or its selection for the number of repetitions indicated in MsgB (e.g., repurpose one or more bits) based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0 (e.g., using DMRS port 1); a PUSCH scrambling ID for a message 3 PUSCH; or a new DMRS sequence for Message 3 PUSCH.

In an aspect, the UE indicates its selection for the configuration in the system information signaling, its selection for the table describing PUCCH resource sets before activating the dedicated PUCCH resource configuration, or its selection for the number of repetitions indicated in the RAR grant (e.g., the CSI request bit) in Msg2, based on at least one of: a parameter associated with message 3 or a part of the content of message 3.

In an aspect, the mapping from at least a bit (e.g., CSI request bit) in the RAR grant in Msg2 or from at least a bit in MsgB to the number of repetitions for PUCCH before the UE activates the dedicated PUCCH resource configuration is indicated in a SIB (e.g., SIB1). In a first example, CSI request bit=1 means a repetition number 4, CSI request bit=0 means a repetition number 1 (i.e., no repetition). In a second example, CSI request bit=1 means a repetition number 8, CSI request bit=0 means a repetition number 1. In an aspect, the network uses the CSI request bit in the RAR grant to indicate a number of repetitions for Msg4 PUCCH or any other PUCCH before the UE activates the dedicated PUCCH resource configuration. In an aspect, the UE indicates its support for the number of repetitions indicated in the RAR grant (e.g., the CSI request bit) in Msg2, or its support for the number of repetitions indicated in MsgB (e.g., repurpose one or more bits) based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0 (e.g., using DMRS port 1); a PUSCH scrambling ID for a message 3 PUSCH; or a new DMRS sequence for Message 3 PUSCH, a parameter associated with message 3; or a part of the content of message 3. In an aspect, the UE transmits a PUCCH with repetitions according to the repetition number indicated in the RAR grant (e.g., the CSI request bit) in Msg2 or in MsgB (e.g., repurpose one or more bits) if before the UE activates the dedicated PUCCH resource configuration. In an aspect, a procedure is shown in FIG. 9. In an aspect, the RRC message is an RRC setup message or an RRC reconfiguration message. For example, referring back to FIG. 7, the UE 504 may receive a PDSCH 702 carrying an RRCSetup msg 702a and a Contention resolution msg 702b. In an aspect, the number of repetitions is indicated based on a parameter in one or more cell-level parameters for the PUCCH.

In an aspect, the number of repetitions is indicated based on a table describing PUCCH resource sets before a dedicated PUCCH configuration (see Table 1 above). In an aspect, the number of repetitions is indicated based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a DMRS port for the message 3 PUSCH other than port 0 (e.g., using DMRS port 1); or a PUSCH scrambling ID for the message 3 PUSCH. In an aspect, the table is determined based on at least one of the parameters of the Message 3 PUSCH, a part of the content of Message 3. Some example parameters are: a DMRS port for the message 3 PUSCH other than port 0, e.g., using DMRS port 1, a cyclic shift of the DMR sequence, or a PUSCH scrambling ID for the message 3 PUSCH, a code point, a spare value of a message type, a field in a medium access control (MAC) subheader, an establishment cause in the RRC message carried in message 3, a spare bit available in an RRC connection message carried in message 3.

At operation 1004, the apparatus is configured to transmit the PUCCH transmission on the PUCCH according to the number of repetitions. For example, referring back to FIG. 7, the apparatus 504 may transmit the PUCCH Tx with repetitions (carrying a HARQ ACK bit) 704 carrying a PUCCH 704a and PUCCH 704b to the base station 502. As another example, referring back to FIG. 8, the apparatus 504 may transmit a second PUCCH Tx with repetitions (carrying a second HARQ ACK/NACK bit) 808 carrying a PUCCH 808a and a PUCCH 808b to the base station 502. In an aspect, if the message 3 repetition number is greater than a threshold, the UE needs to do PUCCH repetition for message 4 HARQ ACK; otherwise, if a condition based on RSRP and UE type (e.g., smart phone vs VSAT) etc. is met, the UE needs to do PUCCH repetition for message 4 HARQ ACK. In an aspect, the PUCCH may further comprise a DMRS bundling configuration having a same DMRS bundling configuration for a message 3 DMRS Physical Uplink Shared Channel (PUSCH) transmission or a message A DMRS PUSCH transmission. In an aspect, the DMRS bundling configuration for the PUCCH carrying Message 4 HARQ ACK or Message B HARQ ACK may be determined by the UE. In an aspect, the network may perform hypothesis testing between DMRS bundling used and DMRS bundling not being used in channel estimation.

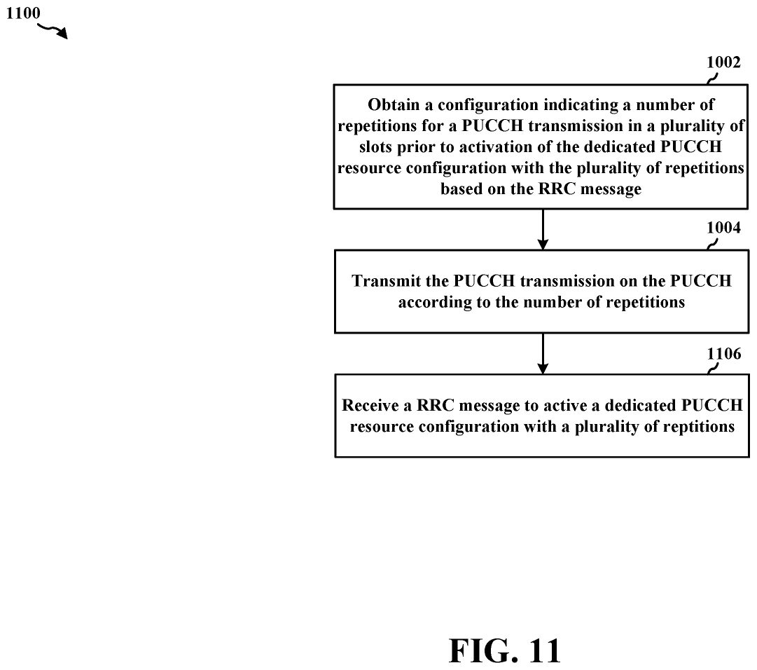

FIG. 11 is a flowchart of a method 1100 of wireless communication at a UE. The method 1100 may be performed by or at a UE (e.g., the UE 104, 450, 504), another wireless communications apparatus (e.g., the apparatus 2002), or one or more components thereof. According to various different aspects, one or more of the illustrated methods 1100 may be omitted, transposed, and/or contemporaneously performed. This method 1100 allows for enhancing the performance of PUCCH carrying the HARQ ACK bit for Message 4 or Message B.

The method 1100 may be performed by an apparatus, such as a configuration component 198, as described above. In some implementations, the method 1100 is performed by processing logic, including hardware, firmware, software, or a combination thereof. In some implementations, the method 1000 is performed by a processor executing code stored in a non-transitory computer-readable medium (e.g., a memory). In the method 1100, operations 1002 and 1004 are performed as described above in connection with FIG. 10.

At operation 1106, the apparatus may be configured to receive the RRC message to activate the dedicated PUCCH resource configuration with the plurality of repetitions. For example, referring back to FIG. 7, the apparatus 504 may receive RRCSetup msg 702a in the PDSCH 702. As another example, referring back to FIG. 8, the apparatus 504, may receive RRCSetup msg 806a in the second scheduled PDSCH 806.

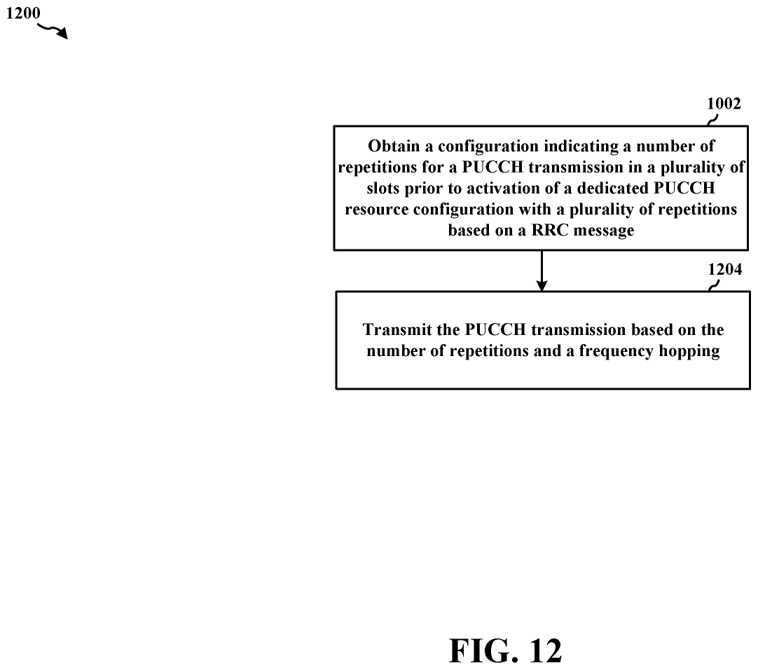

FIG. 12 is a flowchart of a method 1200 of wireless communication at a UE. The method 1200 may be performed by or at a UE (e.g., the UE 104, 450, 504), another wireless communications apparatus (e.g., the apparatus 2002), or one or more components thereof. According to various different aspects, one or more of the illustrated methods 1200 may be omitted, transposed, and/or contemporaneously performed. This method 1200 allows for enhancing the performance of PUCCH carrying the HARQ ACK bit for Message 4 or Message B.

The method 1200 may be performed by an apparatus, such as a configuration component 198, as described above. In some implementations, the method 1200 is performed by processing logic, including hardware, firmware, software, or a combination thereof. In some implementations, the method 1200 is performed by a processor executing code stored in a non-transitory computer-readable medium (e.g., a memory). In the method 1200, operation 1002 is performed as described above in connection with FIG. 10.

At operation 1204, the apparatus may be configured to transmit the PUCCH transmission according to frequency hopping, wherein the frequency hopping is enabled or disabled based on the system information signaling or the cell-level parameters for the PUCCH. In an aspect, the PUCCH transmission repetitions may incorporate different types of frequency hopping such as intra-slot or inter-slot frequency hopping or different patterns of repetition depending on various factors. In an aspect, frequency hopping may be expected at the first half of the slots spanned by the repetitions. In an aspect, if the UE 504 has two or more TX antennas, the UE may perform antenna switching during the slots spanned by the repetitions. In an aspect, antenna switching may occur at the point of frequency hopping. In an aspect, UE may determine whether to perform frequency hopping or not via SIB.

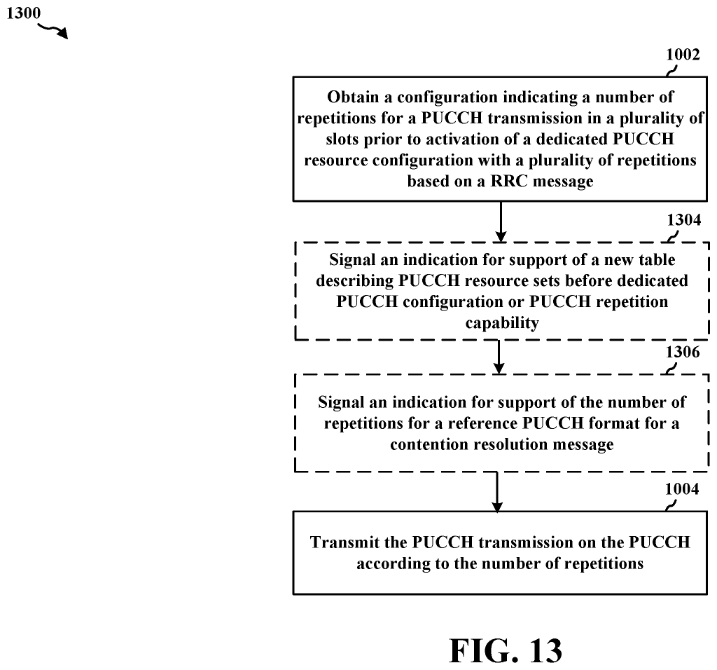

FIG. 13 is a flowchart of a method 1300 of wireless communication at a UE. The method 1300 may be performed by or at a UE (e.g., the UE 104, 450, 504), another wireless communications apparatus (e.g., the apparatus 2002), or one or more components thereof. According to various different aspects, one or more of the illustrated methods 1300 may be omitted, transposed, and/or contemporaneously performed. This method 1300 allows for enhancing the performance of PUCCH carrying the HARQ ACK bit for Message 4 or Message B.

The method 1300 may be performed by an apparatus, such as a configuration component 198, as described above. In some implementations, the method 1300 is performed by processing logic, including hardware, firmware, software, or a combination thereof. In some implementations, the method 1300 is performed by a processor executing code stored in a non-transitory computer-readable medium (e.g., a memory). In the method 1300, operation 1002 and operation 1004 are performed as described above in connection with FIG. 10.

Optionally, at operation 1304, the apparatus is configured to signal an indication for support of a new table for describing PUCCH resource sets before activating a dedicated PUCCH configuration or PUCCH repetition capability based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0; a PUSCH scrambling ID for a message 3 PUSCH; or a new DMRS sequence for Message 3 PUSCH. In an aspect, the PUSCH scrambling ID for the message 3 PUSCH is modified from the PUSCH scrambling ID for the message 3 PUSCH without PUCCH repetition for Message 4. In an aspect, in Message 3 a reserved Logical Channel ID (LCD) code point (or a new extended LCID code) can be used for UL Common Control Channel (CCCH) data to indicate the support. In an aspect, in Message 3, when UL-CCCH1-Message class is used, then no change to LCID but a spare value in UL-CCCH1-MessageType is used to send rrcResumeRequest1 with indication of the support. In an aspect, for the MAC subheader used for UL CCCH data, one “R” field of the two fields may be used to indicate the support. In an aspect, 1 spare bit available in RRC connection request message or RRC connection resume request message is used for the indication of support. In an aspect, the new DMRS sequence is a DMRS sequence that is different from a computed DMRS sequence. As a non-limiting example, the new DMRS sequence may be generated with a random seed formula different from the formula used by a computed DMRS (e.g., for UEs not able to support Message 4 PUCCH repetition) in generating a pseudo-random sequence. In another non-limiting example, the new DMRS sequence may be generated with a cyclic shift relative to the computed DMRS (e.g., for UEs not able to support Message 4 PUCCH repetition). In an aspect, the cyclic shift is used when transform precoding is applied to the PUSCH corresponding to the DMRS.

Optionally, at operation 1306, the apparatus is also configured to signal an indication for support of the number of repetitions for a reference PUCCH format for the message (e.g., a format for the PUCCH transmission in response to the message) based on at least one of: a code point in a Message 3 PUSCH; a spare value of a message type in the Message 3 PUSCH; a field in a medium access control (MAC) subheader; apparatus identification; an establishment cause in the RRC message; or a spare bit available in an RRC connection message.

In an aspect, the configuration is a downlink control information (DCI) including a PUCCH resource indicator (PRI) for scheduling the PDSCH based on the UE implicitly signaling the support for a new table, wherein the configuration uses the new table describing PUCCH resource sets before activating the dedicated PUCCH configuration.

In an aspect, the configuration is a downlink control information (DCI) indicating a PUCCH resource indicator (PRI) and the new table describing PUCCH resource sets before activating the dedicated PUCCH configuration based on the UE implicitly signaling the support for a new table, wherein the configuration uses the new table describing PUCCH resource sets before activating the dedicated PUCCH configuration.

In an aspect, the configuration is a downlink control information (DCI) including a PUCCH resource indicator (PRI) and the number of repetitions based on the UE implicitly signaling the support for a new table when there is no change to the table describing PUCCH resource sets before activating the dedicated PUCCH configuration (see Table 1 above) or SIB (e.g., PUCCH-ConfigCommon IE). In some examples, the DCI may include a Downlink Assignment Index (DAI) field in DCI format 1_0 with CRC scrambled by TC-RNTI used for indication.

In an aspect, a CSI request bit from a random access response (RAR) grant is based on an indication of one of two PUCCH repetition values that the base station supports. As a non-limiting example, there may be no repetition when the bit is 0 and there may be 4 repetitions when the bit is 1. In an aspect, the meaning of the bit value is signaled in a SIB. In an aspect, the meaning of the bit value is written in a technical specification.

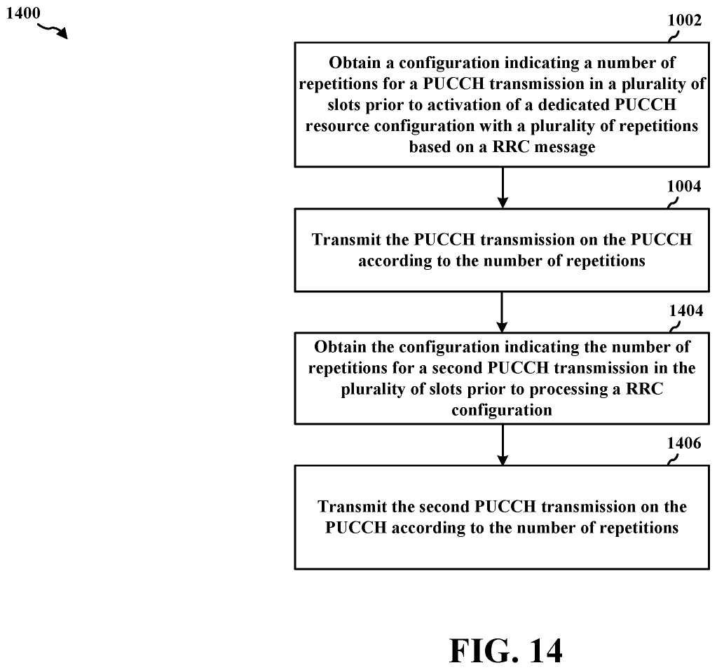

FIG. 14 is a flowchart of a method 1400 of wireless communication at a UE. The method 1400 may be performed by or at a UE (e.g., the UE 104, 450, 504), another wireless communications apparatus (e.g., the apparatus 2002), or one or more components thereof. According to various different aspects, one or more of the illustrated methods 1400 may be omitted, transposed, and/or contemporaneously performed. This method 1400 allows for enhancing the performance of PUCCH carrying the HARQ ACK bit for Message 4 or Message B.

The method 1400 may be performed by an apparatus, such as a configuration component 198, as described above. In some implementations, the method 1400 is performed by processing logic, including hardware, firmware, software, or a combination thereof. In some implementations, the method 1400 is performed by a processor executing code stored in a non-transitory computer-readable medium (e.g., a memory). In the method 1400, operations 1002 and 1004 are performed as described above in connection with FIG. 10.

At operation 1404, the apparatus is also configured obtain the configuration indicating the number of repetitions for a second PUCCH transmission in the plurality of slots prior to processing the RRC message, wherein the second PUCCH transmission includes a second HARQ feedback message in response to receiving the RRC message on a second PDSCH. In an aspect, the second HARQ feedback message may be an RRC message such as an RRC Setup message or RRCReconfiguration message.

At operation 1406, the apparatus is also configured to transmit the second PUCCH transmission on the PUCCH according to the number of repetitions. For example, referring back to FIG. 8, the apparatus 504 may transmit a second PUCCH TX with repetitions (carrying a second HARQ ACK/NACK bit) 808.

In an aspect, wherein the second HARQ feedback message comprises an acknowledgement, or a negative acknowledgment. For example, referring back to FIG. 8, the apparatus 504 may transmit a second PUCCH TX with repetitions carrying a second HARQ ACK/NACK bit 808.

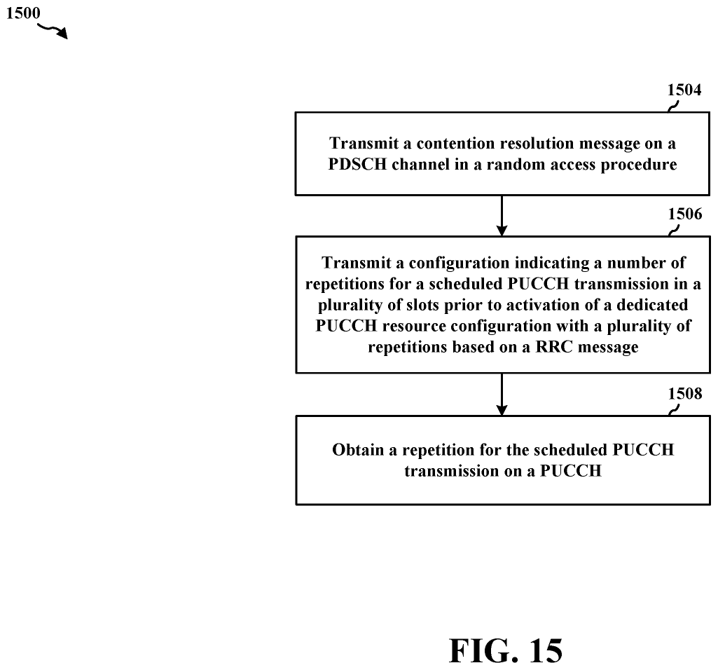

FIG. 15 is a flowchart of a method 1500 of wireless communication at a base station. The method 1500 may be performed by or at a base station (e.g., the base station 102/108, 410, 502), another wireless communications apparatus (e.g., the apparatus 2102), or one or more components thereof. According to various different aspects, one or more of the illustrated methods 1500 may be omitted, transposed, and/or contemporaneously performed. This method 1500 allows for enhancing the performance of PUCCH carrying the HARQ ACK bit for Message 4 or Message B.

The method 1500 may be performed by an apparatus, such as a configuration component 199, as described above. In some implementations, the method 1500 is performed by processing logic, including hardware, firmware, software, or a combination thereof. In some implementations, the method 1500 is performed by a processor executing code stored in a non-transitory computer-readable medium (e.g., a memory).

At operation 1504, the apparatus may be configured to transmit a message on a Physical Downlink Shared Channel (PDSCH) in a random access procedure. In an aspect, the configuration may be a SIB, a PUCCH ConfigCommon, or a DCI. In an aspect, the configuration is based on system information signaling. The message may be one of: a contention resolution message in a 4-step RACH procedure; a MsgB in a 2-step RACH procedure; or any other message before the dedicated PUCCH resource configuration with the plurality of repetitions based on the RRC message. In an aspect, the system information signaling is based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0 (e.g., using DMRS port 1); a PUSCH scrambling ID for a message 3 PUSCH; or a new DMRS sequence for Message 3 PUSCH. In an aspect, the apparatus may be a base station. For example, referring back to FIGS. 7-8, the apparatus may be a base station 502.

At operation 1506, the apparatus may be configured to transmit a configuration indicating a number of repetitions for the scheduled PUCCH transmission in a plurality of slots prior to activation of a dedicated PUCCH resource configuration with a plurality of repetitions based on a radio resource control (RRC) message. The scheduled PUCCH transmission includes a Hybrid Automatic Repeat Request (HARM) feedback message indicating a reception status of the message. In an aspect, the RRC message is an RRC setup message or an RRC reconfiguration message. In an aspect, the configuration is based on system information signaling or PUCCH-ConfigCommon. In an aspect, the number of repetitions is indicated based on a parameter in one or more cell-level parameters for the PUCCH.

In an aspect, the system information signaling, the table describing PUCCH resource sets before receiving the dedicated PUCCH resource configuration, or the number of repetitions indicated based on the CSI request bit in the RAR grant is determined based on at least one of: a parameter associated with message 3 or a part of the content of message 3. In an aspect, the parameter is at least one of: a DMRS port for the message 3 PUSCH other than port 0; a PUSCH scrambling ID for a message 3 PUSCH; or a new DMRS sequence. In an aspect, the part of content is at least one of: a code point; a spare value of a message type; a field in a medium access control (MAC) subheader; an establishment cause in the RRC message carried in message 3; or a spare bit available in an RRC connection message carried in message 3.

In an aspect, the number of repetitions is indicated based on a table describing PUCCH resource sets before the dedicated PUCCH configuration (e.g., see Table 1 above). In an aspect, the apparatus may configure a table describing PUCCH resource sets before activating the dedicated PUCCH configuration. In an aspect, a repetition parameter may be based on the table describing PUCCH resource sets before receiving the dedicated PUCCH configuration. As an example, rows associated with a repetition number may be included in the table describing PUCCH resource sets before activating the dedicated PUCCH configuration. In this example, a bit width value of a field (e.g., PUCCH-resourceCommon field in the PUCCH-ConfigCommon IE) may be increased to a value greater than 4. In another example, a repetition number to a row may be added to the table describing PUCCH resource sets before activating the dedicated PUCCH configuration. In a further example, a new table describing PUCCH resource sets before activating the dedicated PUCCH configuration may be used separately from a table describing PUCCH resource sets before activating the dedicated PUCCH configuration. In yet another example, a parameter may be added to a SIB (e.g., PUCCH-ConfigCommon IE) to indicate a repetition number associated with the PUCCH resource set. In this example, the indication of the repetition number can be on a per PUCCH resource basis. In another example, the table describing PUCCH resource sets before the dedicated PUCCH configuration and SIB (e.g., PUCCH-ConfigCommon IE) may not be modified or changed, but a DCI may still indicate repetition.

In an aspect, a CSI request bit from a random access response (RAR) grant is based on an indication of one of two PUCCH repetition values that the base station supports. In a non-limiting example, there may be no repetition when the bit is 0 and there may be 4 repetitions when the bit is 1. In an aspect, the apparatus may use the CSI request bit in the RAR grant to request a UE to indicate whether it has Message 4 PUCCH repetition capability.

In an aspect, the table describing PUCCH resource sets before the dedicated PUCCH configuration is based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a DMRS port for the message 3 PUSCH other than port 0 (e.g., using DMRS port 1); a PUSCH scrambling ID for the message 3 PUSCH; or a new DMRS sequence for Message 3 PUSCH. In an aspect, the new DMRS sequence is a DMRS sequence that is different from a computed DMRS sequence. As a non-limiting example, the new DMRS sequence may be generated with a random seed formula different from the formula used for a computed DMRS (e.g., for UEs not able to support Message 4 PUCCH repetition) in generating a pseudo-random sequence. In another non-limiting example, the new DMRS sequence may be generated with a cyclic shift that is different from the listed DMRS (e.g., for UEs not able to support Message 4 PUCCH repetition). In an aspect, the cyclic shift is used when transform precoding is applied to the PUSCH corresponding to the DMRS.

In an aspect, the configuration is a downlink control information (DCI) indicating a PUCCH resource indicator (PRI) for scheduling the PDSCH based on the PRI, wherein the configuration uses the new table describing PUCCH resource sets before activating the dedicated PUCCH configuration. In an aspect, the configuration is a downlink control information (DCI) including a PUCCH resource indicator (PRI) and a new table describing PUCCH resource sets before activating the dedicated PUCCH configuration based on the PRI, wherein the configuration uses the new table describing PUCCH resource sets before activating the dedicated PUCCH configuration. In an aspect, wherein the configuration is a downlink control information (DCI) that indicates a PUCCH resource indicator (PRI) and the number of repetitions based on the PM.

At operation 1508, the apparatus may be configured to obtain a repetition for the scheduled PUCCH transmission on the PUCCH.

In an aspect, the configuration comprises a DMRS bundling configuration having a same DMRS bundling configuration for a Message 3 DMRS Physical Uplink Shared Channel (PUSCH) transmission or a message A DMRS PUSCH transmission. In an aspect, the DMRS bundling configuration for the PUCCH carrying Message 4 HARQ ACK or Message B HARQ ACK may be determined by the UE and the base station is configured to perform hypothesis testing between DMRS bundling being used and DMRS bundling not being used in channel estimation.

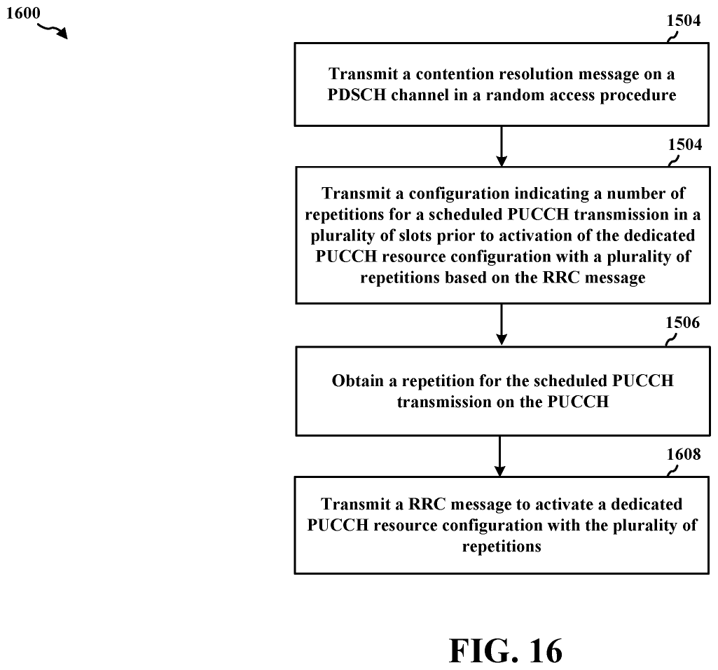

FIG. 16 is a flowchart of a method 1600 of wireless communication at a base station. The method 1600 may be performed by or at a base station (e.g., the base station 102/108, 410, 502), another wireless communications apparatus (e.g., the apparatus 2102), or one or more components thereof. According to various different aspects, one or more of the illustrated methods 1600 may be omitted, transposed, and/or contemporaneously performed. This method 1600 allows for enhancing the performance of PUCCH carrying the HARQ ACK bit for Message 4 or Message B.

The method 1600 may be performed by an apparatus, such as a configuration component 199, as described above. In some implementations, the method 1600 is performed by processing logic, including hardware, firmware, software, or a combination thereof. In some implementations, the method 1600 is performed by a processor executing code stored in a non-transitory computer-readable medium (e.g., a memory). In the method 1600, operations 1504, 1506, and 1508 are performed as described above in connection with FIG. 15.

At operation 1608, the apparatus is configured to transmit the RRC message to activate the dedicated PUCCH resource configuration with the plurality of repetitions. For example, referring back to FIG. 7, the base station 502 may transmit a PDSCH 702 carrying an RRCSetup msg 702a and contention resolution msg 702b. As another example, referring back to FIG. 8, the base station 502 may transmit a second PDSCH 806 carrying an RRC Setup msg 806a.

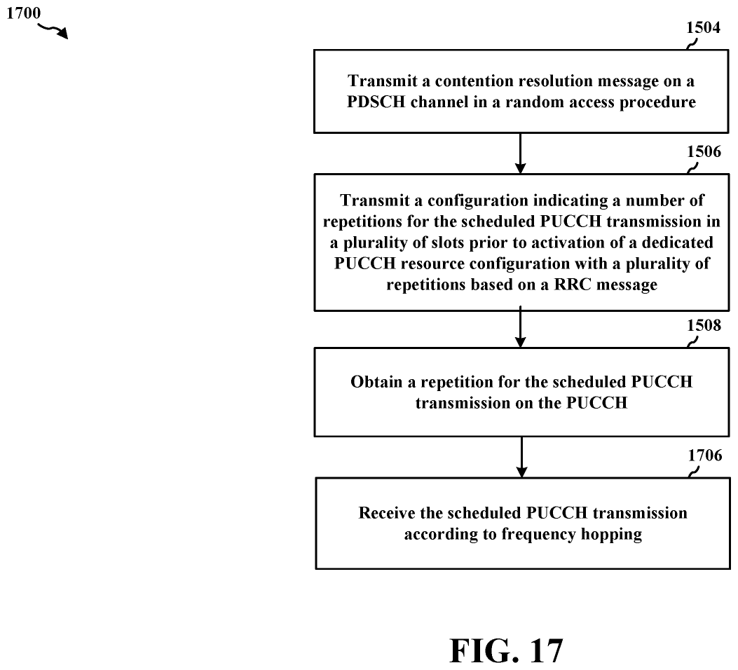

FIG. 17 is a flowchart of a method 1700 of wireless communication at a base station. The method 1700 may be performed by or at a base station (e.g., the base station 102/108, 410, 502), another wireless communications apparatus (e.g., the apparatus 2102), or one or more components thereof. According to various different aspects, one or more of the illustrated methods 1700 may be omitted, transposed, and/or contemporaneously performed. This method 1700 allows for enhancing the performance of PUCCH carrying the HARQ ACK bit for Message 4 or Message B.

The method 1700 may be performed by an apparatus, such as a configuration component 199, as described above. In some implementations, the method 1700 is performed by processing logic, including hardware, firmware, software, or a combination thereof. In some implementations, the method 1700 is performed by a processor executing code stored in a non-transitory computer-readable medium (e.g., a memory). In the method 1700, operations 1504, 1506 and 1508 are performed as described above in connection with FIG. 15.

At operation 1706, the apparatus is configured to receive the scheduled PUCCH transmission according to frequency hopping. The frequency hopping is enabled or disabled based on the system information signaling. In an aspect, the apparatus is configured to indicate whether the frequency hopping is expected or not in the SIB.

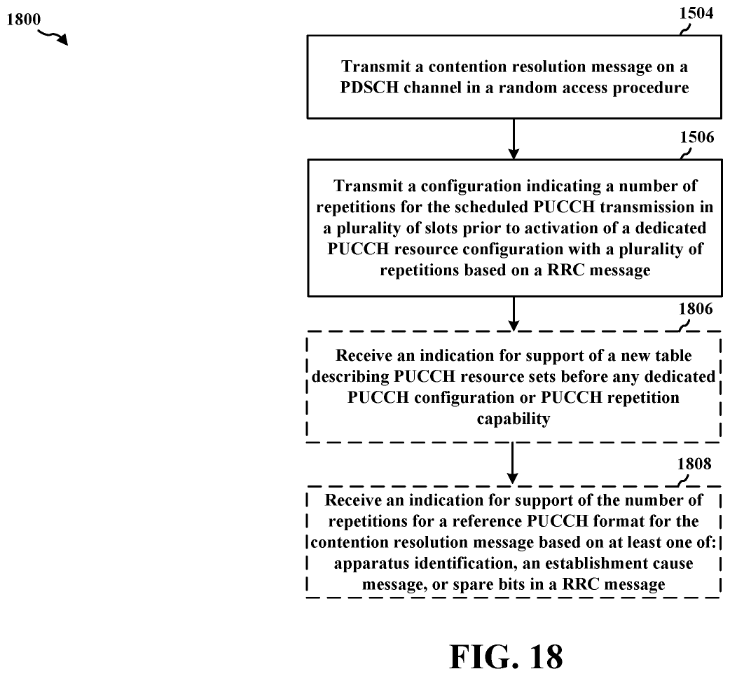

FIG. 18 is a flowchart of a method 1800 of wireless communication at a base station. The method 1800 may be performed by or at a base station (e.g., the base station 102/108, 410, 502), another wireless communications apparatus (e.g., the apparatus 2102), or one or more components thereof. According to various different aspects, one or more of the illustrated methods 1800 may be omitted, transposed, and/or contemporaneously performed. This method 1800 allows for enhancing the performance of PUCCH carrying the HARQ ACK bit for Message 4 or Message B.

The method 1800 may be performed by an apparatus, such as a configuration component 199, as described above. In some implementations, the method 1800 is performed by processing logic, including hardware, firmware, software, or a combination thereof. In some implementations, the method 1800 is performed by a processor executing code stored in a non-transitory computer-readable medium (e.g., a memory). In the method 1800, operations 1504 and 1506 are performed as described above in connection with FIG. 15.

At operation 1806, the apparatus may be configured to receive an indication for support of a table describing PUCCH resource sets before the dedicated PUCCH configuration or PUCCH repetition capability based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0; a PUSCH scrambling ID for a message 3 PUSCH; or a new DMRS sequence for Message 3 PUSCH. In an aspect, the new DMRS sequence is a DMRS sequence that is different from a listed DMRS sequence. As a non-limiting example, the new DMRS sequence may be generated with a random seed formula different from a listed DMRS (e.g., for UEs not able to support Message 4 PUCCH repetition) in generating a pseudo-random. In another non-limiting example, the new DMRS sequence may be generated with a cyclic shift that is different from the listed DMRS (e.g., for UEs not able to support Message 4 PUCCH repetition) when transform precoding is applied to the corresponding PUSCH.

At operation 1808, the apparatus may be configured to receive an indication for support of the number of repetitions for a reference PUCCH format for the message based on at least one of: a code point in a message 3 PUSCH, a spare value of a message type in the message 3 PUSCH; a field in a medium access control (MAC) subheader; apparatus identification; an establishment cause in the RRC message; a spare bit available in an RRC connection message; or a CSI request bit in a random access response (RAR) grant. In an aspect, the apparatus may be configured to indicate what table the UE is to support based on a SIB.

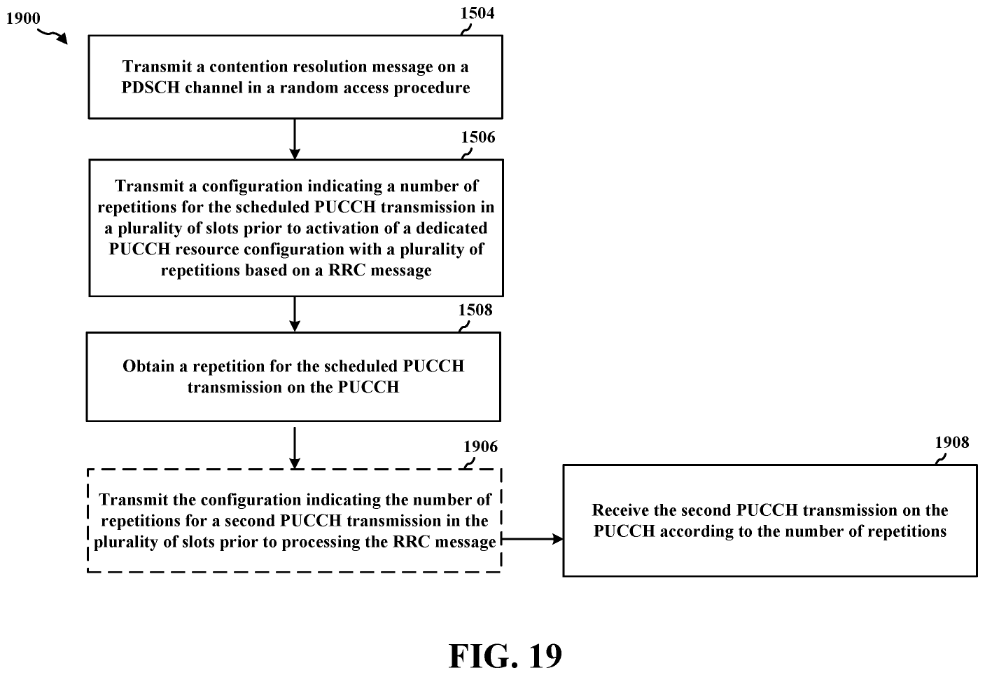

FIG. 19 is a flowchart of a method 1900 of wireless communication at a base station. The method 1900 may be performed by or at a base station (e.g., the base station 102/108, 410, 502), another wireless communications apparatus (e.g., the apparatus 2102), or one or more components thereof. According to various different aspects, one or more of the illustrated methods 1900 may be omitted, transposed, and/or contemporaneously performed. This method 1900 allows for enhancing the performance of PUCCH carrying the HARQ ACK bit for Message 4 or Message B.

The method 1900 may be performed by an apparatus, such as a configuration component 199, as described above. In some implementations, the method 1900 is performed by processing logic, including hardware, firmware, software, or a combination thereof. In some implementations, the method 1900 is performed by a processor executing code stored in a non-transitory computer-readable medium (e.g., a memory). In the method 1900, operations 1504, 1506, and 1508 are performed as described above in connection with FIG. 15.

Optionally, at operation 1906, the apparatus may be configured to transmit the configuration indicating the number of repetitions for a second PUCCH transmission in the plurality of slots prior to processing the RRC message, wherein the second PUCCH transmission includes a second HARQ feedback message in response to receiving the RRC message on a second PDSCH.

At operation 1908, the apparatus may be configured to receive the second PUCCH transmission on the PUCCH according to the number of repetitions.

In an aspect, the second HARQ feedback message comprises an acknowledgement, or a negative acknowledgment.

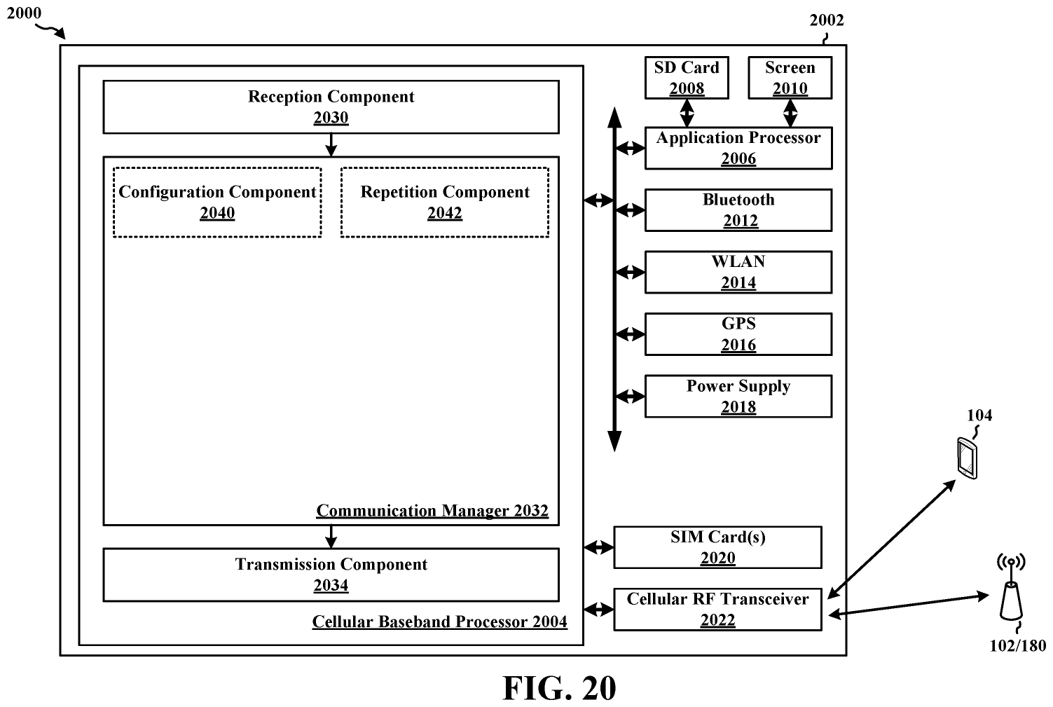

FIG. 20 is a diagram 2000 illustrating an example of a hardware implementation for an apparatus 2002. The apparatus 2002 may be a UE or similar device, or the apparatus 2002 may be a component of a UE or similar device. The apparatus 2002 may include a cellular baseband processor 2004 (also referred to as a modem) and/or a cellular RF transceiver 2022, which may be coupled together and/or integrated into the same package, component, circuit, chip, and/or other circuitry.

In an aspect, the apparatus 2002 may accept or may include one or more subscriber identity modules (SIM) cards 2020, which may include one or more integrated circuits, chips, or similar circuitry, and which may be removable or embedded. The one or more SIM cards 2020 may carry identification and/or authentication information, such as an international mobile subscriber identity (IMSI) and/or IMSI-related key(s). Further, the apparatus 2002 may include one or more of an application processor 2006 coupled to a secure digital (SD) card 2008 and a screen 2010, a Bluetooth module 2012, a wireless local area network (WLAN) module 2014, a Global Positioning System (GPS) module 2016, and/or a power supply 2018.

The cellular baseband processor 2004 communicates through the cellular RF transceiver 2022 with the UE 104 and/or base station 102/180. The cellular baseband processor 2004 may include a computer-readable medium/memory. The computer-readable medium/memory may be non-transitory. The cellular baseband processor 2004 is responsible for general processing, including the execution of software stored on the computer-readable medium/memory. The software, when executed by the cellular baseband processor 2004, causes the cellular baseband processor 2004 to perform the various functions described supra. The computer-readable medium/memory may also be used for storing data that is manipulated by the cellular baseband processor 2004 when executing software. The cellular baseband processor 2004 further includes a reception component 2030, a communication manager 2032, and a transmission component 2034. The communication manager 2032 includes the one or more illustrated components. The components within the communication manager 2032 may be stored in the computer-readable medium/memory and/or configured as hardware within the cellular baseband processor 2004.

In the context of FIG. 4, the cellular baseband processor 2004 may be a component of the UE 450 and may include the memory 460 and/or at least one of the TX processor 468, the RX processor 456, and/or the controller/processor 459. In one configuration, the apparatus 2002 may be a modem chip and/or may be implemented as the cellular baseband processor 2004, while in another configuration, the apparatus 2002 may be the entire UE (e.g., the UE 450 of FIG. 4, the UE 504 in FIGS. 5-8) and may include some or all of the abovementioned components, circuits, chips, and/or other circuitry illustrated in the context of the apparatus 2002. In one configuration, the cellular RF transceiver 2022 may be implemented as at least one of the transmitter 454TX and/or the receiver 454RX.

The reception component 2030 may be configured to receive signaling on a wireless channel, such as signaling from a base station 102/180 or UE 104. The transmission component 2034 may be configured to transmit signaling on a wireless channel, such as signaling to a base station 102/180 or UE 104. The communication manager 2032 may coordinate or manage some or all wireless communications by the apparatus 2002, including across the reception component 2030 and the transmission component 2034.

The reception component 2030 may provide some or all data and/or control information included in received signaling to the communication manager 2032, and the communication manager 2032 may generate and provide some or all of the data and/or control information to be included in transmitted signaling to the transmission component 2034. The communication manager 2032 may include the various illustrated components, including one or more components configured to process received data and/or control information, and/or one or more components configured to generate data and/or control information for transmission.

The communication manager 2032 includes a configuration component 2040 that is configured to obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message, e.g., as described in connection with operation 1002 from FIG. 10. The PUCCH transmission may include a Hybrid Automatic Repeat Request (HARD) feedback message in response to receiving a message on a Physical Downlink Shared Channel (PDSCH) in a random access procedure.

In an aspect, the communication manager 2032 further includes a repetition component 2042 that is configured to transmit the PUCCH transmission on the PUCCH according to the number of repetitions, e.g., as described in connection with operation 1004 from FIG. 10. As an example, referring to FIG. 7, the UE 450 may be configured to transmit the PUCCH transmission 704 on the PUCCH according to the first number of repetitions 704a, 704b. As another example, referring to FIG. 8, the UE 504 may be configured to transmit the PUCCH transmission 804 on the PUCCH according to the first number of repetitions (e.g., PUCCH 804a, PUCCH 804b).

The apparatus 2002 may include additional components that perform some or all of the blocks, operations, signaling, etc. of the algorithm(s) in the aforementioned call flow diagram(s) and/or flowchart(s) of FIGS. 6-14. As such, some or all of the blocks, operations, signaling, etc. in the aforementioned call flow diagram(s) and/or flowchart(s) of FIGS. 6-14 may be performed by one or more components and the apparatus 2002 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2002, and in particular the cellular baseband processor 2004, may include means for obtaining a configuration indicating a number of repetitions for a physical uplink control channel (PUCCH) transmission in a plurality of slots prior to activation of a dedicated PUCCH resource configuration with a plurality of repetitions based on a radio resource control (RRC) message, wherein the PUCCH transmission includes a Hybrid Automatic Repeat Request (HARQ) feedback message in response to receiving a message on a Physical Downlink Shared Channel (PDSCH) in a random access procedure, e.g., as described in connection with operation 1002 from FIG. 10 and means for transmitting the PUCCH transmission on the PUCCH according to the number of repetitions, e.g., as described in connection with operation 1004 from FIG. 10. As another example, referring to FIG. 7, the UE 504 may transmit the PUCCH transmission 704 on the PUCCH according to the number of repetitions.

The aforementioned means may be one or more of the aforementioned components of the apparatus 2002 configured to perform the functions recited by the aforementioned means. As described supra, the apparatus 2002 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

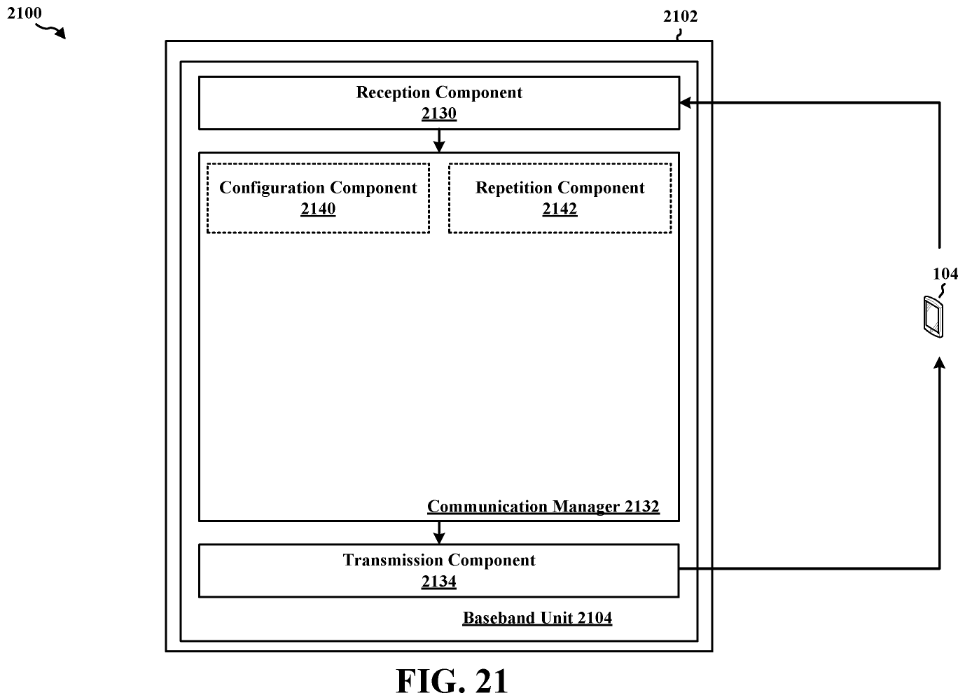

FIG. 21 is a diagram 2100 illustrating an example of a hardware implementation for an apparatus 2102. The apparatus 2102 may be a base station or similar device or system, or the apparatus 2102 may be a component of a base station or similar device or system. The apparatus 2102 may include a baseband unit 2104. The baseband unit 2104 may communicate through a cellular RF transceiver. For example, the baseband unit 2104 may communicate through a cellular RF transceiver with a UE 104, such as for downlink and/or uplink communication, and/or with a base station 102/180, such as for IAB.

The baseband unit 2104 may include a computer-readable medium/memory, which may be non-transitory. The baseband unit 2104 is responsible for general processing, including the execution of software stored on the computer-readable medium/memory. The software, when executed by the baseband unit 2104, causes the baseband unit 2104 to perform the various functions described supra. The computer-readable medium/memory may also be used for storing data that is manipulated by the baseband unit 2104 when executing software. The baseband unit 2104 further includes a reception component 2130, a communication manager 2132, and a transmission component 2134. The communication manager 2132 includes the one or more illustrated components. The components within the communication manager 2132 may be stored in the computer-readable medium/memory and/or configured as hardware within the baseband unit 2104. The baseband unit 2104 may be a component of the base station 410 and may include the memory 476 and/or at least one of the TX processor 416, the RX processor 470, and the controller/processor 475.

The reception component 2130 may be configured to receive signaling on a wireless channel, such as signaling from a UE 104 or base station 102/180. The transmission component 2134 may be configured to transmit signaling on a wireless channel, such as signaling to a UE 104 or base station 102/180. The communication manager 2132 may coordinate or manage some or all wireless communications by the apparatus 2102, including across the reception component 2130 and the transmission component 2134.

The reception component 2130 may provide some or all data and/or control information included in received signaling to the communication manager 2132, and the communication manager 2132 may generate and provide some or all of the data and/or control information to be included in transmitted signaling to the transmission component 2134. The communication manager 2132 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 2132 includes a configuration component 2140 that is configured to transmit a configuration indicating a number of repetitions for the scheduled PUCCH transmission in a plurality of slots prior to activation of a dedicated PUCCH resource configuration with a plurality of repetitions based on a radio resource control (RRC) message, e.g., as described in connection with operation 1506 from FIG. 15. In some aspects, the communication manager 2132 may include a repetition component 2142 that is configured to obtain the repetition for the scheduled PUCCH transmission on the PUCCH, e.g., as described in connection with operation 1508 from FIG. 15. As another example, referring to FIG. 7, the base station 502 may obtain the first repetition 704a for the scheduled PUCCH transmission 704 on the PUCCH and other repetitions 704b of the scheduled PUCCH transmission according to the number of repetitions.

The apparatus 2102 may include additional components that perform some or all of the blocks, operations, signaling, etc. of the algorithm(s) in the aforementioned call flow diagram(s) and/or flowchart(s) of FIGS. 5-8 and 15-19. As such, some or all of the blocks, operations, signaling, etc. in the aforementioned call flow diagram(s) and/or flowchart(s) of FIGS. 5-8 and 15-19 may be performed by a component and the apparatus 2102 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2102, and in particular the baseband unit 2104, may include means for transmitting information indicating a scheduled physical uplink control channel (PUCCH) transmission on a PUCCH resource, wherein the means for transmitting is further configured to transmit a message on a Physical Downlink Shared Channel (PDSCH) channel in a random access procedure, and to transmit a configuration indicating a number of repetitions for the scheduled PUCCH transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARQ) feedback message indicating a reception status of the message, and means for obtaining the repetition for the scheduled PUCCH transmission on the PUCCH.

The aforementioned means may be one or more of the aforementioned components of the apparatus 2102 configured to perform the functions recited by the aforementioned means. As described supra, the apparatus 2102 may include the TX Processor 416, the RX Processor 470, and the controller/processor 475. As such, in one configuration, the aforementioned means may be the TX Processor 416, the RX Processor 470, and the controller/processor 475 configured to perform the functions recited by the aforementioned means.

As described in further detail in the present disclosure, PUCCH repetition may be performed to increase coverage extension during random access procedures. In particular, a UE may perform repetition on a PUCCH transmission that contains a HARQ-ACK feedback for a contention resolution PDSCH transmission in a random access procedure. The PUCCH transmission may then be transmitted on resources prior to activation of a dedicated PUCCH resource configuration.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

### SOME ADDITIONAL EXAMPLES

The aspects described herein additionally include one or more of the following implementation examples described in the following numbered clauses.

Aspect 1. An apparatus for wireless communication, comprising:
a memory; and
at least one processor coupled to the memory and configured to:

obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message, wherein the PUCCH transmission includes a Hybrid Automatic Repeat Request (HARQ) feedback message in response to receiving a message on a Physical Downlink Shared Channel (PDSCH) in a random access procedure; and
transmit the PUCCH transmission on a PUCCH according to the number of repetitions.

Aspect 2. The apparatus of aspect 1, wherein the apparatus is a user equipment (UE).

Aspect 3. The apparatus of aspects 1 or 2, wherein the at least one processor is further configured to: receive the RRC message to activate the dedicated PUCCH resource configuration with the plurality of repetitions.

Aspect 4. The apparatus of any of the aspects 1 to 3, wherein the RRC message is an RRC setup message or an RRC reconfiguration message.

Aspect 5. The apparatus of any of aspects 1 to 4, wherein the configuration is based on system information signaling.

Aspect 6. The apparatus of any of aspects 1 to 5, wherein the number of repetitions is indicated based on a parameter in one or more cell-level parameters for the PUCCH.

Aspect 7. The apparatus of any of the aspects 1 to 6, wherein the at least one processor is further configured to: transmit the PUCCH transmission according to frequency hopping, wherein the frequency hopping is enabled or disabled based on the system information signaling.

Aspect 8. The apparatus of any of aspects 1 to 7, wherein the number of repetitions is indicated based on a table describing PUCCH resource sets before the dedicated PUCCH configuration.

Aspect 9. The apparatus of any of the aspects 1 to 8, wherein the number of repetitions is indicated based on a channel state information (CSI) request bit in a random access response (RAR) grant.

Aspect 10. The apparatus of any of the aspects 1 to 9, wherein the number of repetitions is the repetitions to be used by the scheduled PUCCH transmission before activating the dedicated PUCCH resource configuration.

Aspect 11. The apparatus of any of the aspects 1 to 10, wherein the number of repetitions is indicated in a system information block (SIB).

Aspect 12. The apparatus of any of the aspects 1 to 11, wherein a channel state information (CSI) request bit in a random access response (RAR) grant indicates a conditional configuration that allows a user equipment (UE) to use PUCCH enhancements based on the system information signaling or the number of repetitions before the dedicated PUCCH resource configuration is activated conditioned on that the UE indicates support for the PUCCH enhancements.

Aspect 13. The apparatus of any of the aspects 1 to 12, wherein the support for the configuration in the system information signaling, the support for the table describing PUCCH resource sets before activating the dedicated PUCCH resource configuration, or the support for the number of repetitions indicated based on the CSI request bit in the RAR grant is indicated based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0, e.g., using DMRS port 1; a PUSCH scrambling ID for a message 3 PUSCH; or a new DMRS sequence for message 3 PUSCH.

Aspect 14. The apparatus of any of the aspects 1 to 13, wherein the support for the configuration in the system information signaling, the support for the table describing PUCCH resource sets before receiving the dedicated PUCCH resource configuration, or the support for the number of repetitions indicated based on the CSI request bit in the RAR grant is indicated based on at least one of: a parameter associated with message 3 and a part of the content of message 3.

Aspect 15. The apparatus of any of the aspects 1 to 14, wherein the parameter is at least one of: a DMRS port for the message 3 PUSCH other than port 0; a PUSCH scrambling ID for a message 3 PUSCH; or a new DMRS sequence.

Aspect 16. The apparatus of any of the aspects 1 to 15, wherein the part of content is at least one of: a code point, a spare value of a message type; a field in a medium access control (MAC) subheader; an establishment cause in the RRC message carried in message 3; or a spare bit available in an RRC connection message carried in message 3.

Aspect 17. The apparatus of any of the aspects 1 to 16, wherein the configuration further comprises a DMRS bundling configuration having a same DMRS bundling configuration for a message 3 DMRS Physical Uplink Shared Channel (PUSCH) transmission or a message A DMRS PUSCH transmission.

Aspect 18. The apparatus of any of the aspects 1 to 17, wherein the at least one processor is further configured to: signal an indication for support of a new table describing PUCCH resource sets before activating the dedicated PUCCH resource configuration or a PUCCH repetition capability based on at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a DMRS port for the message 3 other than port 0; a PUSCH scrambling ID for a message 3 PUSCH; or a new DMRS sequence.

Aspect 19. The apparatus of any of the aspects 1 to 18, wherein the at least one processor is further configured to: signal an indication for support of the number of repetitions for a reference PUCCH format for the message based on at least one of: a code point in a message 3 PUSCH; a spare value of a message type in the message 3 PUSCH; a field in a medium access control (MAC) subheader; an apparatus identification; an establishment cause in the RRC message; or a spare bit available in an RRC connection message.

Aspect 20. The apparatus of any of the aspects 1 to 19, wherein the configuration is a downlink control information (DCI) that indicates a PUCCH resource indicator (PM) for scheduling the PDSCH based on the PRI, wherein the configuration uses the new table describing PUCCH resource sets before activating the dedicated PUCCH resource configuration.

Aspect 21. The apparatus of any of the aspects 1 to 20, wherein the configuration is a downlink control information (DCI) that indicates a PUCCH resource indicator (PRI) and the new table describing PUCCH resource sets before the dedicated PUCCH resource configuration based on the PM, wherein the configuration uses the new table describing PUCCH resource sets before activating the dedicated PUCCH resource configuration.

Aspect 22. The apparatus of any of the aspects 1 to 21, wherein the configuration is a downlink control information (DCI) that indicates a PUCCH resource indicator (PRI) and the number of repetitions based on the PM.

Aspect 23. The apparatus of any of the aspects 1 to 22, wherein the at least one processor is further configured to:
obtain the configuration indicating the number of repetitions for a second PUCCH transmission in the plurality of slots prior to processing the RRC message, wherein the second PUCCH transmission includes a second HARQ feedback message in response to receiving the RRC message on a second PDSCH; and
transmit the second PUCCH transmission on the PUCCH according to the number of repetitions.

Aspect 24. The apparatus of any of the aspects 1 to 23, wherein the second HARQ feedback message comprises an acknowledge, or a negative acknowledgment.

Aspect 25. An apparatus for wireless communication, comprising:
a memory; and
at least one processor coupled to the memory and configured to:

transmit a message on a Physical Downlink Shared Channel (PDSCH) in a random access procedure;
transmit a configuration indicating a number of repetitions for a scheduled Physical Uplink Control Channel (PUCCH) transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARD) feedback message indicating a reception status of the message; and
obtain a repetition for the scheduled PUCCH transmission on a PUCCH.

Aspect 26. The apparatus of aspect 25, wherein the apparatus is a base station.

Aspect 27. The apparatus of aspects 25 or 26, wherein the at least one processor is further configured to: transmit the RRC message to activate the dedicated PUCCH resource configuration with the plurality of repetitions.

Aspect 28. The apparatus of any of the aspects 25 to 27, wherein the RRC message is an RRC setup message or an RRC reconfiguration message.

Aspect 29. The apparatus of any of the aspects 25 to 28, wherein the configuration is based on system information signaling.

Aspect 30. The apparatus of any of the aspects 25 to 29, wherein the number of repetitions is indicated based on a parameter in one or more cell-level parameters for the PUCCH.

Aspect 31. The apparatus of any of the aspects 25 to 30, wherein the at least one processor is further configured to:
receive the scheduled PUCCH transmission according to frequency hopping, wherein the frequency hopping is enabled or disabled based on the system information signaling.

Aspect 32. The apparatus of any of the aspects 25 to 31, wherein the number of repetitions is indicated based on a table describing PUCCH resource sets before receiving the dedicated PUCCH resource configuration.

Aspect 33. The apparatus of any of the aspects 25 to 32, wherein the number of repetitions is indicated based on a channel state information (CSI) request bit in a random access response (RAR) grant.

Aspect 34. The apparatus of any of the aspects 25 to 33, wherein the number of repetitions is the repetitions to be used by the scheduled PUCCH transmission before activating the dedicated PUCCH resource configuration.

Aspect 35. The apparatus of any of the aspects 25 to 34, wherein the number of repetitions is indicated in a system information block (SIB).

Aspect 36. The apparatus of any of the aspects 25 to 35, wherein a channel state information (CSI) request bit in a random access response (RAR) grant indicates a conditional configuration that allows a user equipment (UE) to use PUCCH enhancements based on the system information signaling or the number of repetitions before the dedicated PUCCH resource configuration.

Aspect 37. The apparatus of any of the aspects 25 to 36, wherein the support for the configuration in the system information signaling, the support for the table describing PUCCH resource sets before activating the dedicated PUCCH resource configuration, or the support for the number of repetitions indicated based on the CSI request bit in the RAR grant is indicated based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0; a PUSCH scrambling ID for a message 3 PUSCH; or a new DMRS sequence for message 3 PUSCH.

Aspect 38. The apparatus of any of the aspect 25 to 37, wherein the support for the configuration in the system information signaling, the support for the table describing PUCCH resource sets before receiving the dedicated PUCCH resource configuration, or the support for the number of repetitions indicated based on the CSI request bit in the RAR grant is indicated based on at least one of: a parameter associated with message 3; and a part of the content of message 3.

Aspect 39. The apparatus of any of the aspect 25 to 38, wherein the parameter is at least one of: a DMRS port for the message 3 PUSCH other than port 0, a PUSCH scrambling ID for a message 3 PUSCH, or a new DMRS sequence.

Aspect 40. The apparatus of any of the aspect 25 to 39, wherein the part of content is at least one of: a code point; a spare value of a message type; a field in a medium access control (MAC) subheader; an establishment cause in the RRC message carried in message 3; or a spare bit available in an RRC connection message carried in message 3.

Aspect 41. The apparatus of any of the aspects 25 to 40, wherein the configuration further comprises a DMRS bundling configuration having a same DMRS bundling configuration for a message 3 DMRS Physical Uplink Shared Channel (PUSCH) transmission or a message A DMRS PUSCH transmission.

Aspect 42. The apparatus of any of the aspects 25 to 41, wherein the at least one processor is further configured to:

receive an indication for support of a new table describing receiving PUCCH resource sets before activating the dedicated PUCCH resource configuration or a PUCCH repetition capability based on at least one of: a particular physical random access channel (PRACH) format; a subset of PRACH sequences; a subset of RACH occasions; a message 3 PUSCH repetition number greater than a predefined value, the message 3 PUSCH repetition number which links a PUCCH repetition number to the number of repetitions; a DMRS port for the message 3 PUSCH other than port 0 (e.g., using DMRS port 1); a PUSCH scrambling ID for message 3 PUSCH; or a new DMRS sequence.

Aspect 43. The apparatus of any of the aspects 25 to 42, wherein the at least one processor is further configured to:
receive an indication for support of the number of repetitions for a reference PUCCH format for the message based on at least one of: a code point in a message 3 PUSCH;
a spare value of a message type in the message 3 PUSCH; a field in a medium access control (MAC) subheader; an apparatus identification; an establishment cause in the RRC message; a spare bit available in an RRC connection message; or a CSI request bit in a random access response (RAR) grant.

Aspect 44. The apparatus of any of the aspects 25 to 43, wherein the configuration is a downlink control information (DCI) that indicates a PUCCH resource indicator (PRI) for scheduling the PDSCH based on the PRI, wherein the configuration uses the new table describing PUCCH resource sets before activating the dedicated PUCCH resource configuration.

Aspect 45. The apparatus of any of the aspects 25 to 44, wherein the configuration is a downlink control information (DCI) that indicates a PUCCH resource indicator (PRI) and a new table describing PUCCH resource sets before activating the dedicated PUCCH resource configuration based on the PRI, wherein the configuration uses the new table describing PUCCH resource sets before activating the dedicated PUCCH resource configuration.

Aspect 46. The apparatus of any of the aspects 25 to 45 wherein the configuration is a downlink control information (DCI) that indicates a PUCCH resource indicator (PRI) and the number of repetitions based on the PRI.

Aspect 47. The apparatus of any of the 25 to 46, wherein the at least one processor is further configured to:
transmit the configuration indicating the number of repetitions for a second PUCCH transmission in the plurality of slots prior to processing the RRC message, wherein the second PUCCH transmission includes a second HARQ feedback message in response to receiving the RRC message on a second PDSCH; and
receive the second PUCCH transmission on the PUCCH according to the number of repetitions

Aspect 48. The apparatus of any of the aspects 25 to 47, wherein the second HARQ feedback message comprises an acknowledge, or a negative acknowledgment.

Aspect 49. A method of wireless communication at a (UE) user equipment, comprising:
obtaining a configuration indicating a number of repetitions for a physical uplink control channel (PUCCH) transmission in a plurality of slots prior to activation of a dedicated PUCCH resource configuration with a plurality of repetitions based on a radio resource control (RRC) message, wherein the PUCCH transmission includes a Hybrid Automatic Repeat Request (HARQ) feedback message in response to receiving a message on a Physical Downlink Shared Channel (PDSCH) in a random access procedure; and
transmitting the PUCCH transmission on the PUCCH according to the number of repetitions.

Aspect 50. The method of aspect 49, further comprising: receiving the RRC message to activate the dedicated PUCCH resource configuration with the plurality of repetitions.

Aspect 51. The method of aspect 49 or 50, wherein the RRC message is an RRC setup message or an RRC reconfiguration message.

Aspect 52. The method of any of the aspects 49 to 51, wherein the configuration is based on system information signaling.

Aspect 53. The method of any of the aspects 49 to 52, wherein the number of repetitions is indicated based on a parameter in one or more cell-level parameters for the PUCCH.

Aspect 54. The method of any of the aspects 49 to 53, further comprising:

transmitting the PUCCH transmission according to frequency hopping, wherein the frequency hopping is enabled or disabled based on the system information signaling.

Aspect 55. The method of any of the aspects 49 to 54, wherein the number of repetitions is indicated based on a table describing PUCCH resource sets before receiving the dedicated PUCCH resource configuration.

Aspect 56. The method of any of the aspects 49 to 55, wherein the number of repetitions is indicated based on a channel state information (CSI) request bit in a random access response (RAR) grant.

Aspect 57. The method of any of the aspects 49 to 56, wherein the number of repetitions is the repetitions to be used by the scheduled PUCCH transmission before activating the dedicated PUCCH resource configuration.

Aspect 58. The method of any of the aspects 49 to 57, wherein the number of repetitions is indicated in a system information block (SIB).

Aspect 59. The method of any of the aspects 49 to 58, wherein a channel state information (CSI) request bit in a random access response (RAR) grant indicates a conditional configuration that allows a user equipment (UE) to use PUCCH enhancements based on the system information signaling or the number of repetitions before the dedicated PUCCH resource configuration is activated conditioned on that the UE indicates support for the PUCCH enhancements.

Aspect 60. The method of any of the aspect 49 to 59, wherein the system information signaling, the table describing PUCCH resource sets before receiving the dedicated PUCCH resource configuration is determined, or the number of repetitions indicated based on the CSI request bit in the RAR grant based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0 (e.g., using DMRS port 1); a PUSCH scrambling ID for a message 3 PUSCH; or a new DMRS sequence for Message 3 PUSCH.

Aspect 61. The method of any of the aspects 49 to 60, wherein the support for the configuration in the system information signaling, the support for the table describing PUCCH resource sets before receiving the dedicated PUCCH resource configuration, or the support for the number of repetitions indicated based on the CSI request bit in the RAR grant is indicated based on at least one of: a parameter associated with message 3 and a part of the content of message 3.

Aspect 62. The method of any of the aspects 49 to 61, wherein the parameter is at least one of: a DMRS port for the message 3 PUSCH other than port 0; a PUSCH scrambling ID for a message 3 PUSCH; or a new DMRS sequence.

Aspect 63. The method of any of the aspects 49 to 62, wherein the part of content is at least one of: a code point; a spare value of a message type; a field in a medium access control (MAC) subheader; an establishment cause in the RRC message carried in message 3; or a spare bit available in an RRC connection message carried in message 3.

Aspect 64. The method of any of the aspects 49 to 63, wherein the configuration further comprises a DMRS bundling configuration having a same DMRS bundling configuration for a message 3 DMRS Physical Uplink Shared Channel (PUSCH) transmission or a message A DMRS PUSCH transmission.

Aspect 65. The method of any of the aspects 49 to 64, further comprising:

signaling an indication for support of a new table describing PUCCH resource sets before activating the dedicated PUCCH resource configuration or a PUCCH repetition capability based on at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a DMRS port for the message 3 other than port 0; a PUSCH scrambling ID for a message 3 PUSCH; or a new DMRS sequence.

Aspect 66. The method of any of the aspects 49 to 65, further comprising:
signaling an indication for support of the number of repetitions for a reference PUCCH format for the message based on at least one of: a code point in a message 3 PUSCH;
a spare value of a message type in the message 3 PUSCH; a field in a medium access control (MAC) subheader; an apparatus identification; an establishment cause in the RRC message; or a spare bit available in an RRC connection message.

Aspect 67. The method of any of the aspects 49 to 66, wherein the configuration is a downlink control information (DCI) that indicates a PUCCH resource indicator (PM) for scheduling the PDSCH based on the PRI, wherein the configuration uses the new table describing PUCCH resource sets before activating the dedicated PUCCH resource configuration.

Aspect 68. The method of any of the aspects 49 to 67, wherein the configuration is a downlink control information (DCI) that indicates a PUCCH resource indicator (PRI) and a new table describing PUCCH resource sets before the dedicated PUCCH resource configuration based on the PRI, wherein the configuration uses the new table describing PUCCH resource sets before activating the dedicated PUCCH resource configuration.

Aspect 69. The method of any of the aspects 49 to 68, wherein the configuration is a downlink control information (DCI) that indicates a PUCCH resource indicator (PRI) and the number of repetitions based on the PM.

Aspect 70. The method of any of the aspects 49 to 69, further comprising:
obtaining the configuration indicating the number of repetitions for a second PUCCH transmission in the plurality of slots prior to processing the RRC message, wherein the second PUCCH transmission includes a second HARQ feedback message in response to receiving the RRC message on a second PDSCH; and
transmitting the second PUCCH transmission on the PUCCH according to the number of repetitions.

Aspect 71. The method of any of the aspects 49 to 70, wherein the second HARQ feedback message comprises an acknowledge, or a negative acknowledgment.

Aspect 72. A method of wireless communication at a base station, comprising:
transmitting a message on a Physical Downlink Shared Channel (PDSCH) in a random access procedure;
transmitting a configuration indicating a number of repetitions for a scheduled Physical Uplink Control Channel (PUCCH) transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARQ) feedback message indicating a reception status of the message; and
obtaining a repetition for the scheduled PUCCH transmission on a PUCCH.

Aspect 73. The method of aspect 72, further comprising:
transmitting the RRC message to activate the dedicated PUCCH resource configuration with the plurality of repetitions.

Aspect 74. The method of aspect 72 or 73, wherein the configuration is based on system information signaling.

Aspect 75. The method of any of the aspects 72 to 74, wherein the number of repetitions is indicated based on a parameter in one or more cell-level parameters for the PUCCH.

Aspect 76. The method of any of the aspects 72 to 75, further comprising:
receiving the scheduled PUCCH transmission according to frequency hopping, wherein the frequency hopping is enabled or disabled based on the system information signaling.

Aspect 77. The method of any of the aspects 72 to 76, wherein the number of repetitions is indicated based on a table describing PUCCH resource sets before receiving the dedicated PUCCH resource configuration.

Aspect 78. The method of any of the aspects 72 to 77, wherein the number of repetitions is indicated based on a channel state information (CSI) request bit in a random access response (RAR) grant.

Aspect 79. The method of any of the aspects 72 to 78, wherein the number of repetitions is the repetitions to be used by the PUCCH transmission before activating the dedicated PUCCH resource configuration.

Aspect 80. The method of any of the aspects 72 to 79, wherein the number of repetitions is indicated in a system information block (SIB).

Aspect 81. The method of any of the aspects 72 to 80, wherein a channel state information (CSI) request bit in a random access response (RAR) grant indicates a conditional configuration that allows a user equipment (UE) to use PUCCH enhancements based on the system information signaling or the number of repetitions before the dedicated PUCCH resource configuration.

Aspect 82. The method of any of the aspects 72 to 81, wherein the support for the configuration in the system information signaling, the support for the table describing PUCCH resource sets before activating the dedicated PUCCH resource configuration, or the support for the number of repetitions indicated based on the CSI request bit in the RAR grant is indicated based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions, a demodulated reference signal (DMRS) port for the message 3 other than port 0 (e.g., using DMRS port 1); a PUSCH scrambling ID for a message 3 PUSCH; or a new DMRS sequence for message 3 PUSCH.

Aspect 83. The method of any of the aspects 72 to 82, wherein the support for the configuration in the system information signaling, the support for the table describing PUCCH resource sets before receiving the dedicated PUCCH resource configuration, or the support for the number of repetitions indicated based on the CSI request bit in the RAR grant is indicated based on at least one of: a parameter associated with message 3 and a part of the content of message 3.

Aspect 84. The method of any of the aspects 72 to 83, wherein the parameter is at least one of: a DMRS port for the message 3 PUSCH other than port 0; a PUSCH scrambling ID for a message 3 PUSCH; or a new DMRS sequence.

Aspect 85. The method of any of the aspects 72 to 84, wherein the part of content is at least one of: a code point; a spare value of a message type; a field in a medium access control (MAC) subheader; an establishment cause in the RRC message carried in message 3; or a spare bit available in an RRC connection message carried in message 3.

Aspect 86. The method of any of the aspects 72 to 85, wherein the configuration further comprises a DMRS bundling configuration having a same DMRS bundling configuration for a message 3 DMRS Physical Uplink Shared Channel (PUSCH) transmission or a message A DMRS PUSCH transmission.

Aspect 87. The method of any of the aspects 72 to 86, further comprising:
receiving an indication for support of a new table describing receiving PUCCH resource sets before activating the dedicated PUCCH resource configuration or a PUCCH repetition capability based on at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a DMRS port for the message 3 PUSCH other than port 0 (e.g., using DMRS port 1); a PUSCH scrambling ID for message 3 PUSCH; or a new DMRS sequence.

Aspect 88. The method of any of the aspects 72 to 87, further comprising:
receiving an indication for support of the number of repetitions for a reference PUCCH format for the message based on at least one of: a code point in a message 3 PUSCH; a spare value of a message type in the message 3 PUSCH; a field in a medium access control (MAC) subheader; an apparatus identification; an establishment cause in the RRC message; a spare bit available in an RRC connection message; or a CSI request bit in a random access response (RAR) grant.

Aspect 89. The method of any of the aspects 72 to 88, wherein the configuration is a downlink control information (DCI) that indicates a PUCCH resource indicator (PM) for scheduling the PDSCH based on the PRI, wherein the configuration uses the new table describing PUCCH resource sets before activating the dedicated PUCCH resource configuration.

Aspect 90. The method of any of the aspects 72 to 89, wherein the configuration is a downlink control information (DCI) that indicates a PUCCH resource indicator (PRI) and a new table describing PUCCH resource sets before activating the dedicated PUCCH resource configuration based on the PM, wherein the configuration uses the new table describing PUCCH resource sets before activating the dedicated PUCCH resource configuration.

Aspect 91. The method of any of the aspects 72 to 90, wherein the configuration is a downlink control information (DCI) that indicates a PUCCH resource indicator (PRI) and the number of repetitions based on the PM.

Aspect 92. The method of any of the aspects 72 to 91, further comprising:

transmitting the configuration indicating the number of repetitions for a second PUCCH transmission in the plurality of slots prior to processing the RRC message, wherein the second PUCCH transmission includes a second HARQ feedback message in response to receiving the RRC message on a second PDSCH; and
receiving the second PUCCH transmission on the PUCCH according to the number of repetitions.

Aspect 93. The method of any of the aspects 72 to 91, wherein the second HARQ feedback message comprises an acknowledge, or a negative acknowledgment.

Aspect 94. An apparatus for wireless communication, comprising:
means for obtaining a configuration indicating a number of repetitions for a physical uplink control channel (PUCCH) transmission in a plurality of slots prior to activation of a dedicated PUCCH resource configuration with a plurality of repetitions based on a radio resource control (RRC) message, wherein the PUCCH transmission includes a Hybrid Automatic Repeat Request (HARQ) feedback message in response to receiving a message on a Physical Downlink Shared Channel (PDSCH) in a random access procedure; and
means for transmitting the PUCCH transmission on the PUCCH according to the number of repetitions.

Aspect 95. An apparatus for wireless communication, comprising:
means for transmitting a message on a Physical Downlink Shared Channel (PDSCH) channel in a random access procedure;
means for transmitting a configuration indicating a number of repetitions for a scheduled Physical Downlink Shared Channel (PUCCH) transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARQ) feedback message indicating a reception status of the message; and
means for obtaining a repetition for the scheduled PUCCH transmission on a PUCCH.

Aspect 96. A non-transitory computer-readable medium storing computer-executable code, the code when executed by a processor cause the processor to:
obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message, wherein the PUCCH transmission includes a Hybrid Automatic Repeat Request (HARQ) feedback message in response to receiving a message on a Physical Downlink Shared Channel (PDSCH) in a random access procedure; and
transmit the PUCCH transmission on the PUCCH according to the number of repetitions.

Aspect 97. A non-transitory computer-readable medium storing computer-executable code, the code when executed by a processor cause the processor to:
transmit a message on a Physical Downlink Shared Channel (PDSCH) channel in a random access procedure;
transmit a configuration indicating a number of repetitions for a scheduled Physical Downlink Shared Channel (PUCCH) transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARQ) feedback message indicating a reception status of the message; and
obtain a repetition for the scheduled PUCCH transmission on the PUCCH.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the aspects disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the aspects described in this disclosure may be readily apparent to persons having ordinary skill in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, various features that are described in this specification in the context of separate aspects also can be implemented in combination in a single aspect. Conversely, various features that are described in the context of a single aspect also can be implemented in multiple aspects separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

What is claimed is:

1. An apparatus for wireless communication, comprising:
a memory; and
at least one processor coupled to the memory and configured to:
obtain a configuration indicating a number of repetitions for a physical uplink control channel (PUCCH) transmission in a plurality of slots prior to activation of a dedicated PUCCH resource configuration with a plurality of repetitions based on a radio resource control (RRC) message, wherein the PUCCH transmission includes a Hybrid Automatic Repeat Request (HARQ) feedback message in response to receiving a message on a Physical Downlink Shared Channel (PDSCH) in a random access procedure; and
transmit the PUCCH transmission on a PUCCH according to the number of repetitions.

2. The apparatus of claim 1, wherein the message is one of: a contention resolution message in a 4-step Random-Access Channel (RACH) procedure; a Message B (MsgB) in a 2-step RACH procedure; or a message before the dedicated PUCCH resource configuration with the plurality of repetitions based on the RRC message.

3. The apparatus of claim 1, wherein the at least one processor is further configured to:
receive the RRC message to activate the dedicated PUCCH resource configuration with the plurality of repetitions.

4. The apparatus of claim 1, wherein the configuration is based on system information signaling.

5. The apparatus of claim 4, wherein the number of repetitions is indicated based on a parameter in one or more cell-level parameters for the PUCCH.

6. The apparatus of claim 4, wherein the at least one processor is further configured to:
transmit the PUCCH transmission according to frequency hopping, wherein the frequency hopping is enabled or disabled based on the system information signaling.

7. The apparatus of claim 1, wherein the number of repetitions is indicated based on a table describing PUCCH resource sets before receiving the dedicated PUCCH resource configuration.

8. The apparatus of claim 1, wherein the at least one processor is further configured to:
signal an indication for support of a new table describing PUCCH resource sets before activating the dedicated PUCCH resource configuration or a PUCCH repetition capability based on at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a DMRS port for the message 3 other than port 0; a PUSCH scrambling ID for a message 3 PUSCH; or a new DMRS sequence.

9. The apparatus of claim 1, wherein the configuration is a downlink control information (DCI) that indicates a PUCCH resource indicator (PRI) and the number of repetitions based on the PRI.

10. An apparatus for wireless communication, comprising:
a memory; and
at least one processor coupled to the memory and configured to:
transmit a message on a Physical Downlink Shared Channel (PDSCH) in a random access procedure;
transmit a configuration indicating a number of repetitions for a scheduled Physical Uplink Control Channel (PUCCH) transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARQ) feedback message indicating a reception status of the message; and
obtain a repetition for the scheduled PUCCH transmission on a PUCCH.

11. The apparatus of claim 10, wherein the message is one of: a contention resolution message in a 4-step Random-Access Channel (RACH) procedure; a MessageB (MsgB) in a 2-step RACH procedure; or a message before the dedicated PUCCH resource configuration with the plurality of repetitions based on the RRC message.

12. The apparatus of claim 10, wherein the at least one processor is further configured to:
transmit the RRC message to activate the dedicated PUCCH resource configuration with the plurality of repetitions.

13. The apparatus of claim 10, wherein the configuration is based on system information signaling.

14. The apparatus of claim 13, wherein the at least one processor is further configured to:
receive the scheduled PUCCH transmission according to frequency hopping, wherein the frequency hopping is enabled or disabled based on the system information signaling.

15. The apparatus of claim 13, wherein the at least one processor is further configured to:
transmit the configuration indicating the number of repetitions for a second PUCCH transmission in the plurality of slots prior to processing the RRC message, wherein the second PUCCH transmission includes a second HARQ feedback message in response to receiving the RRC message on a second PDSCH; and
receive the second PUCCH transmission on the PUCCH according to the number of repetitions.

16. The apparatus of claim 10, wherein the number of repetitions is indicated based on a channel state information (CSI) request bit in a random access response (RAR) grant.

17. The apparatus of claim 16, wherein the number of repetitions is the repetitions to be used by the scheduled PUCCH transmission before activating the dedicated PUCCH resource configuration.

18. The apparatus of claim 10, wherein the configuration further comprises a DMRS bundling configuration having a same DMRS bundling configuration for a message 3 DMRS Physical Uplink Shared Channel (PUSCH) transmission or a message A DMRS PUSCH transmission.

19. The apparatus of claim 10, wherein the at least one processor is further configured to:
receive an indication for support of a new table describing PUCCH resource sets before activating the dedicated PUCCH resource configuration or a PUCCH repetition capability based on at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a DMRS port for the message 3 other than port 0; a PUSCH scrambling ID for a message 3 PUSCH; or a new DMRS sequence.

20. The apparatus of claim 19, wherein the configuration is a downlink control information (DCI) that indicates a PUCCH resource indicator (PRI) and the new table describing PUCCH resource sets before the dedicated PUCCH resource configuration based on the indication, wherein the configuration uses the new table describing PUCCH resource sets before activating the dedicated PUCCH resource configuration.

21. The apparatus of claim 10, wherein the at least one processor is further configured to:
receive an indication for support of the number of repetitions for a reference PUCCH format for the message based on at least one of: a code point in a message 3 PUSCH; a spare value of a message type in the message 3 PUSCH; a field in a medium access control (MAC) subheader; an apparatus identification; an establishment cause in the RRC message; or a spare bit available in an RRC connection message.

22. A method of wireless communication at a user equipment (UE), comprising:
obtaining a configuration indicating a number of repetitions for a physical uplink control channel (PUCCH) transmission in a plurality of slots prior to activation of a dedicated PUCCH resource configuration with a plurality of repetitions based on a radio resource control (RRC) message, wherein the PUCCH transmission includes a Hybrid Automatic Repeat Request (HARQ) feedback message in response to receiving a message on a Physical Downlink Shared Channel (PDSCH) in a random access procedure; and
transmitting the PUCCH transmission on the PUCCH according to the number of repetitions.

23. The method of claim 22, wherein the message is one of: a contention resolution message in a 4-step Random-Access Channel (RACH) procedure; a MessageB (MsgB) in a 2-step RACH procedure; or a message before the dedicated PUCCH resource configuration with the plurality of repetitions based on the RRC message.

24. The method of claim 22, wherein a channel state information (CSI) request bit in a random access response (RAR) grant indicates a conditional configuration that allows a user equipment (UE) to use PUCCH enhancements based on system information signaling or the number of repetitions before the dedicated PUCCH resource configuration is activated conditioned on that the UE indicates support for the PUCCH enhancements.

25. The method of claim 22, wherein the number of repetitions is indicated based on a channel state information (CSI) request bit in a random access response (RAR) grant.

26. The method of claim 25, wherein the number of repetitions is the repetitions to be used by the PUCCH transmission before activating the dedicated PUCCH resource configuration.

27. The method of claim 22, wherein the configuration is based on system information signaling.

28. The method of claim 27, wherein support for the configuration in the system information signaling is based on a selection of at least one of: a particular physical random access channel (PRACH) format; a subset of PRACH sequences; a subset of RACH occasions; a message 3 PUSCH repetition number greater than a predefined value; the message 3 PUSCH repetition number which links a PUCCH repetition number to the number of repetitions; a demodulated reference signal (DMRS) port for the message 3 other than port 0; a PUSCH scrambling ID for a message 3 PUSCH; or a new DMRS sequence for message 3 PUSCH.

29. The method of claim 22, wherein the configuration further comprises a DMRS bundling configuration having a same DMRS bundling configuration for a message 3 DMRS Physical Uplink Shared Channel (PUSCH) transmission or a message A DMRS PUSCH transmission.

30. A non-transitory computer-readable medium storing computer-executable code, the code when executed by a processor cause the processor to:
transmit a message on a Physical Downlink Shared Channel (PDSCH) channel in a random access procedure;
transmit a configuration indicating a number of repetitions for a scheduled Physical Uplink Control Channel (PUCCH) transmission in a plurality of slots prior to activation of a dedicated PUCCH resource configuration with a plurality of repetitions based on a radio resource control (RRC) message, wherein the scheduled PUCCH transmission includes a Hybrid Automatic Repeat Request (HARQ) feedback message indicating a reception status of the message; and
obtain a repetition for the scheduled PUCCH transmission on the PUCCH.
